(19) United States
(12) Patent Application Publication
(10) Pub. No.: US 2010/0027442 A1
(43) Pub. Date: Feb. 4, 2010

(54) CONSTRUCTING SCALABLE OVERLAYS FOR PUB-SUB WITH MANY TOPICS: THE GREEDY JOIN-LEAVE ALGORITHM

(75) Inventors: Gregory Chockler, Haifa (IL); Roie Melamed, Haifa (IL); Yoav Tock, Nesher (IL); Roman Vitenberg, Oslo (NO)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/183,319

(22) Filed: Jul. 31, 2008

(51) Int. Cl. H04L 12/28

(52) U.S. Cl. 370/254

(57) ABSTRACT

A method and system for constructing a single topic-connected overlay network are disclosed. A link contribution array, which stores sets of edges in an order according contribution values, is provided. A highest contribution index indicates a highest element in the link contribution array. The method includes performing, at every iteration, a Greedy Merge (GM) algorithm for selecting an edge from the highest element in the link contribution array, removing the selected edge from the link contribution array, and adding the selected edge to a set of overlay edges. After the selected edge is added to the set of overlay edges, contribution values of other edges are updated. The GM algorithm terminates when all elements in the link contribution array become empty. As an output, the GM algorithm generates a single topic-connected overlay network for all topics. A Greedy Join (GJ) and Greedy Leave (GL) functions are also disclosed.

### BACKGROUND OF THE INVENTION

1. Fields of the Invention

The present invention relates to a publish/subscribe network. More particularly, the present invention relates to constructing a topic-connected overlay network (e.g., all nodes on an application layer in TCP/IP protocol are connected through edges for each topic) on the publish/subscribe network.

2. Description of the Prior Art

A publish/subscribe (hereinafter “pub/sub”) is an asynchronous messaging mechanism where message senders (i.e., publisher or publishing client) do not send messages to specific receivers (i.e., subscriber or subscribing client). In a publish/subscribe network, any number of consumers (i.e., subscribers) of information can receive messages that are provided by one or more producers (i.e., publishers) of that information. In this case, a producer of information is called a publisher and a consumer of that information is called a subscriber.

Publish/subscribe messaging provides the concept of a topic on which any number of interested consumers of information can subscribe in order to register their interest. This is similar to the way that a person might subscribe only to magazines about topics in which they are interested. Each topic provides particular event or state information.

A publisher can send messages containing information about a particular topic to all subscribers to that topic, without any knowledge of how many subscribers there are, or the details of the nodes that host those subscribers. Because of this, publish/subscribe

messaging completely decouples the provider of the information from the consumer of that information.

In many practical applications (e.g., a stock-market monitoring engine), it is common that nodes (e.g., subscriber or publisher) in publish/subscribe network are interested in more than one topic, and that interests (e.g., subscribing topics) of different nodes are correlated. Due to a simple interface and inherent scalability, pub/sub is commonly used to support many-to-many communication in a wide variety of popular Internet applications, such as stock-market monitoring engines, RSS (Real Simple Syndication) feeds, an on-line gaming, an application integration, etc.

Detlef Schoder, et al. (“Core Concepts in Peer-to-Peer Networking”, Detlef Scholder, Kai Fischbach and Christian Schmitt, Idea Group Inc., 2005) describes that a peer-to-peer (hereinafter “P2P”) network is a network in which all nodes provide resources (e.g., bandwidth, storage space, and computing power). Thus, when a new node added in a peer-to-peer network, a total resource capacity increases. In a client-server environment, adding more clients can slow data transfer for all users. A P2P network does not have a notion of clients and servers, but only equal peer nodes that simultaneously function as both clients and servers to other nodes on the network.

Jian Gao, et al. (“Overlay Networks to Support Internet Emergency Preparedness Services”, Jian Gao and Cory Beard, December 2004) describes that an overlay network is a virtual network that is built on a top of one or more existing networks. Nodes in the overlay network can be thought of as being connected by virtual or logical links, each of which corresponds to a path, perhaps through many physical links, in an underlying network. A lot of peer-to-peer networks are overlay networks because peer-to-peer networks run on top of Internet. A P2P overlay network comprises all participating peers as network nodes. There are paths between any two nodes that know each other, if a participating peer knows a location of another peer in the P2P network.

As known, a TCP/IP model comprises an application layer (i.e., a layer where a high-level protocol (e.g., File Transfer Protocol, a Simple Mail Transfer Protocol) is used by most applications for a network communication), a transport layer (i.e., a layer being responsible for end-to-end (i.e., source to destination, publisher to subscriber) message transfer independent of an underlying network along with error control, fragmentation and flow control), a network layer (i.e., a layer being responsible for end-to-end packet delivery and including functional and procedural means for transferring variable length data sequences from a source to a destination via one or more networks while maintaining a quality of service and error control functions), a data link layer (i.e., a layer being responsible for moving packets from the network layer on two different hosts and performing a data link function such as adding a packet header) and a physical layer (i.e., a layer being responsible for encoding and transmission of data in the form of bits over network communication media). A physical network is realized by Internet using routers, switches, etc. When a group of nodes connect to each other using TCP/IP model, the group of nodes forms a connectivity graph or a network, which is overlaid on the top of the physical network (e.g., Internet), and is called as an overlay network. Because the overlay network is realized in the application layer in the TCP/IP model, the overlay network is also called as an application-layer network.

In an undirected graph, two nodes are considered “connected”, if there is a path between them, Otherwise, they are called “disconnected”. A graph/network is called connected if every pair of nodes in the graph/network is connected directly or indirectly. A directed graph is called weakly connected if replacing all of its directed edges with undirected edges produces a connected graph. A directed graph is strongly connected if it contains a directed path for every pair of nodes.

A diameter of a network/graph is a maximal number of hops (i.e., a hop is a trip that a data packet takes from one router or an intermediate point to another in the network) that a data packet takes to get from any node to any other node. The diameter of a graph/network is infinite if the graph/network is not connected.

Meloche et al. (European patent application publication number: EP 1,916,800, Title: “Peer-to-peer overlay graph construction”, Application Number: EP20070119402) discusses adding a node to an overlay graph and removing a node from the overlay graph. Awerbuch et al. (“Towards scalable and robust overlay networks” in the 6^{th} International Workshop on Peer-to-Peer Systems (IPTPS), 2007) discusses joining a peer node to a peer-to-peer system and leaving a peer node from the peer-to-peer system.

However, existing solutions do not discuss a dynamic construction of an overlay network in publish/subscribe mechanism with a small number of links or edges.

Therefore, it is highly desirable to provide a system and method to dynamically construct a topic-connected overlay network in pub/sub mechanism with a small number of links.

### SUMMARY OF THE INVENTION

In one embodiment, there is provided a method for constructing a topic-connected overlay network on a publish/subscribe system having a plurality of nodes representing computing devices in said overlay network comprising:

deriving the nodes in the publish/subscribe system, a link contribution array including sets of edges as elements and a highest contribution index keeping track of a highest element in the link contribution array, the elements in the link contribution array being sorted in an order according to contribution values of sets of edges, said sets of edges for connecting the nodes, the highest element including edges with a highest contribution value;

initializing a set of overlay edges, the set of overlay edges connecting the nodes for constructing the topic-connected overlay network;

removing an edge from the highest element in the link contribution array, the highest element being indicated by the highest contribution index;

determining whether the highest contribution index is larger than zero;

adding the removed edge to the set of overlay edges, if the highest contribution index is larger than zero;

updating contribution values of other edges, after adding the removed edge to the set of overlay edges;

updating the highest contribution index, if the highest contribution index is larger than zero and the highest element in the link contribution array is empty; and

outputting the set of overlay edges, when all elements in the link contribution array become empty, wherein

the nodes are organized in a single connected component for every topic by the outputted set of overlay edges and the topic-connected overlay network is constructed.

In one embodiment, there is provided a system for constructing a topic-connected overlay network on a publish/subscribe system having a plurality of nodes representing computing devices in said overlay network comprising:

means for deriving the nodes in the publish/subscribe system, a link contribution array including sets of edges as elements and a highest contribution index keeping track of a highest element in the link contribution array, the elements in the link contribution array being sorted in an order according to contribution values of sets of edges, said sets of edges for connecting the nodes, the highest element including edges with a highest contribution value;

means for initializing a set of overlay edges, the set of overlay edges connecting the nodes for constructing the topic-connected overlay network;

means for removing an edge from the highest element in the link contribution array, the highest element being indicated by the highest contribution index;

means for determining whether the highest contribution index is larger than zero;

means for adding the removed edge to the set of overlay edges, if the highest contribution index is larger than zero;

means for updating contribution values of other edges, after adding the removed edge to the set of overlay edges;

means for updating the highest contribution index, if the highest contribution index is larger than zero and the highest element in the link contribution array is empty; and

means for outputting the set of overlay edges, when all elements in the link contribution array become empty, wherein

the nodes are organized in a single connected component for every topic by the outputted set of overlay edges and the topic-connected overlay network is constructed.

In one embodiment, the present invention allows nodes to dynamically join and leave an overlay network.

In one embodiment, while constructing an overlay network, removing an edge from the highest element (i.e., an array entry with highest contribution value; a contribution value of an edge is generally the number of common topics between two separate components being connected trough the edge) in the link contribution array (i.e., an array including a set of edges sorted according to descending contribution values of the set of edges) is performed in random or a deterministic manner.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1A depicts an overlay networks with six nodes and two topics.

FIG. 1B depicts a subgraph (i.e., a subset of a graph) induced by a topic t1.

FIG. 1C depicts a topic-connected overlay network.

FIGS. 2A-2F depict an example of Greedy Merge algorithm, with five nodes and seven topics.

FIG. 3 depicts an example of Greedy Join algorithm.

FIG. 4 depicts an example of Greedy Leave algorithm.

FIG. 5 depicts a flow chart of an initialization phase of Greedy Merge algorithm.

FIG. 6A-6B depicts flow charts of an overlay construction using Greedy Merge algorithm.

FIG. 7 depicts a flow chart of an initialization phase of Greedy Join algorithm.

FIGS. 8A-8B depicts flow charts of an initialization phase of Greedy Leave algorithm.

### DETAILED DESCRIPTION

The present invention focuses on decentralized implementations of a topic-based pub/sub system where nodes (e.g., subscribers or publishers) do not rely on intermediate agent(s) (e.g., servers or message brokers) to forward their messages but rather communicate in a peer-to-peer fashion, effectively forming an application-layer network or an overlay network. In this overlay network, an efficient routing protocol (e.g., IGRP (Interior Gateway Routing Protocol), EGP (Exterior Gateway Protocol), OSPF (Open Shortest Path First), etc.) becomes a major factor affecting performance of the pub/sub system. A routing complexity is greatly reduced if all the nodes interested in a same topic t can be organized into a connected dissemination graph (e.g., a tree) that consists of only the nodes interested in t

A network or graph is considered “connected” if there is a path from every node to every other node in the graph (A path means that there are edge(s) from a node A to a node B, possibly via other nodes). A necessary requirement enabling a construction of the dissemination graph is “topic-connectivity”. The topic-connectivity means that, for each topic t, subgraphs induced by nodes interested in t is connected. In other words, a topic-connectivity for a certain topic T means that a subgraph induced by T forms a single connected component. A subgraph induced by T comprises of nodes interested in T and edges connecting the nodes. A connected component is a collection of edges and nodes such that there is a path between any two nodes on the component. A connected component that contains a node v contains all the nodes that can be reached from the node v and edges between them. A node with no edge is a singleton connected component. An overlay network is topic-connected, when all the topics have a property of topic-connectivity. A topic-connected components of an overlay network for a topic I are connected components of a subgraph of the overlay network induced by the topic t. An overlay network is topic-connected if for each topic t, there is at most one topic-connected component in a subgraph induced by topic I.

In order to achieve topic-connectivity, a separate overlay network for each topic can be created in a pub/sub system. However, creating each overlay network for each topic requires that the number of links maintained by each node is roughly equal to twice number of topics that the node subscribes. Therefore, creating an overlay network per a topic does not scale with respect to the number of topics that a node subscribes.

Inventors of the present invention has published “Constructing scalable overlay networks for pub/sub with many topics: Problems, algorithms, and evaluation” (hereinafter “Chockler”), In 26^{th} ACM Symposium on Principles of Distributed Computing (PODC), 2007. Chockler states constructing a topic-connected overlay with the minimum number of edges are NP-complete (i.e., verifying that an overlay is a topic-connected overlay takes polynomial times of the number of nodes and edges; to find out a topic-connected overlay with the minimum number of edges, a very large number of configurations has to be searched. The number of configuration to be searched grows exponentially with the number of nodes and topics.). Chockler further states that it is possible to efficiently approximate constructing a topic-connected overlay with the minimum number of edges by using a greedy algorithm called a Greedy Merge (GM) algorithm. Therefore, the whole contents and disclosure of Chockler (“Constructing scalable overlay networks for pub/sub with many topics: Problems, algorithms, and evaluation”, G Chockler, R. Melamed, Y. Tock and R. Vitenberg, In 26^{th} ACM Symposium on Principles of Distributed Computing (PODC), 2007) is incorporated by a reference as if fully set forth herein.

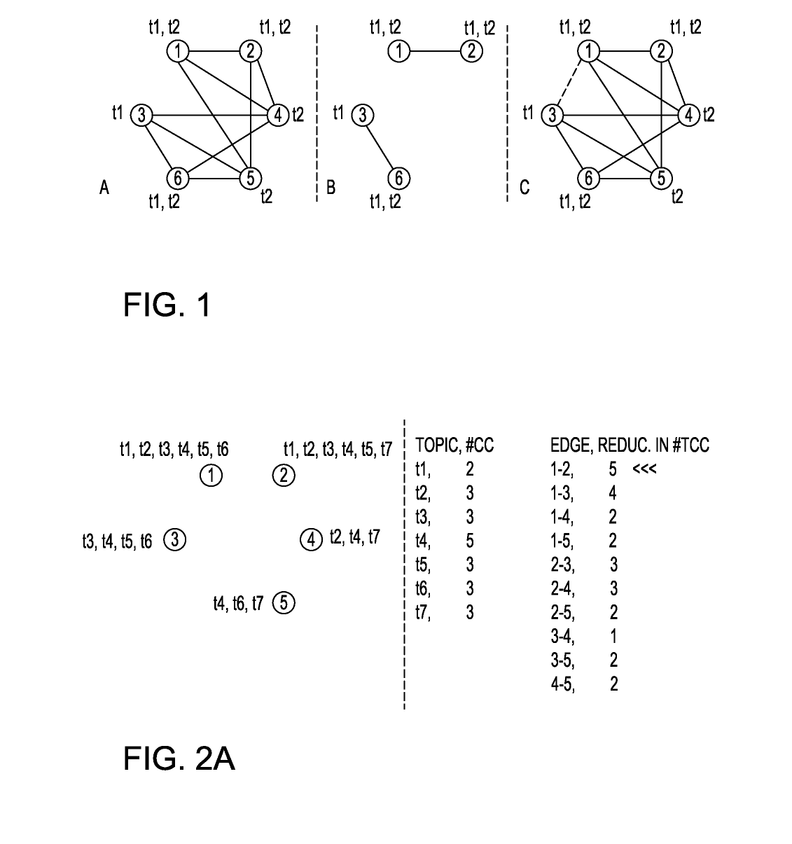

FIG. 1A illustrates an overlay network with six nodes (e.g., node 1, 2, 3, 4, 5 and 6) and two topics (e.g., t1 and t2). However, the present invention is not limited to the number of nodes and the number topics in the overlay network. FIG. 1 is illustrated for an exemplary purpose. In one embodiment, there are a plurality of nodes in the overlay network in a pub/sub system. The nodes, which are representing computing devices (e.g., laptops, servers, mainframes, desktops, PDAs, smart phones, playstations, etc.), are interested in (e.g., publishes or subscribes) a plurality of topics. FIG. 1B illustrates a corresponding subgraph induced by topic t1. The subgraph induced by t1 includes two connected components (i.e., a connected component consists of a node 1, a node 2 and an edge connecting the node 1 and node 2, another connected component consists of a node 3, a node 6 and an edge connecting the node 3 and node 6). Therefore, the overlay network shown in FIG. 1A is not topic-connected, because the subgraph induced by t1 includes more than one connected components. However, the overlay network shown in FIG. 1A includes a single connected component for topic t2 (i.e., the subgraph induced by t2 includes a single connected component (not shown separately)). FIG. 1C illustrates adding an edge between node 1 and node 3 let the overlay network become topic-connected (i.e., the subgraph induced by t1 now includes a single connected component, and the subgraph induced by t2 includes a single connected component).

In one embodiment, the present invention does not distinguish between publishers and subscribers. In other words, both publishers and subscribers of a topic t are interested in the topic t. In one embodiment, a publisher of a topic t is also a subscriber of topic t. Therefore, when a node is interested in a topic t, the node publishes a message of a topic t or subscribes a message of the topic t. In another embodiment, there are only publishers producing messages of a plurality of topics. In an alternative embodiment, there are only subscribers receiving message of a plurality of topics.

For the rest of description, it is denoted:

V is a set of nodes in a pub/sub system. |V| is the number of nodes in the pub/sub network. (The operator |S| denotes the number of elements in set S.)

T is a set of topics in a pub/sub system. |T| is the number of topics in the pub/sub system.

Int(v,t) is a boolean function that maps a node v and a topic t to either true or false. Int(v,t) is true if and only if the node v is interested in the topic t.

E is a set of edges in a pub/sub system. |E| is the number of edges in the pub/sub system.

(v,w) is an edge between a node v and a node w.

G=(V,E) is an overlay network containing a set of nodes V and a set of edges E.

A greedy merge (GM) algorithm is an approximation algorithm (i.e., a sub-optimal or approximation solution) of an optimal algorithm for minimizing the number of links or edges needed to create a topic-connected overlay network for topics. The GM algorithm receives interest assignments (e.g., Int(v,t)) of all the nodes as inputs and produces a set of edges such that a resulting overlay (i.e., an overlay generated by running the GM algorithm) is topic-connected. The GM algorithm starts without edges, where each node is a singleton connected component for each topic that the node is interested in. Thus, if topic t has k nodes interested in it, at the start there are k singleton connected components for that topic (i.e., a singleton connected component is composed of a single node). The number of nodes interested in a topic t can be determined by counting the number of elements (i.e., the number of nodes) in a set {every v, such that Int(v,t)=true}. The GM algorithm proceeds by adding one edge at a time. Edges are chosen such that each newly added edge merges disjoint connected components for the largest number of topics (or, equivalently, maximally reduces a total number of topic-connected components). The GM algorithm stops when for every topic there is at most one connected component. In other words, the GM algorithm constructs a topic-connected overlay network with a small number of links (i.e., the number of links created by the GM algorithm is within a log-arithmetic factor of the number of links created by an optimal solution).

Following data structures are used in rest of description:

OuputOverlayEdges: a set of overlay edges (i.e., edges connecting nodes to construct a topic-connected overlay network). The OuputOverlayEdges is initially an empty set, Ø.

Nodes: a two-dimensional array, with |V| rows and |T| columns. Each entry in this array is a set of nodes. For a given topic t and node v, Nodes[v][t] stores a set of nodes belonging to a same topic-connected component as v for topic t. If node v is not interested in topic t, then Nodes[v] [t] contains an empty set.

LinkContrib (i.e., a link contribution array): a one dimensional array of size |T|. Each element in this LinkContrib array is a set of edges. If an edge e=(v,w) is in one of the sets that reside in the LinkContrib array, then the edge e is not in the set OuputOverlayEdges. If an edge e=(v,w) is in LinkContrib[i] (i.e., edge e is in a set in a location i in the array LinkContrib), then adding the edge to the overlay network reduce the number of topic-connected components by i, where 1≦i≦|T|.

HighestContrib (i.e., a highest contribution index) holds a biggest integer i for which LinkContrib[i] is not empty set. The highest contribution index can be between |T| and 0.

The OutputOverlayEdges contains a set of edges that construct a topic-connected overlay network. The OutputOverlayEdges starts as an empty set, and in each iteration a single edge is added to the OutputOverlayEdges. When the GM algorithm terminates, this OutputOverlayEdges set contains all the edges of a constructed overlay network.

The two-dimensional array Nodes[v] [t] contains all the topic-connected components. Each entry in the array is a set of nodes. For a given topic t and node v, Nodes[v][t] holds the set of nodes—the nodes that belong to the same topic-connected component as v (for topic t). That is, at the subgraph induced by topic t, the Nodes[v][t] holds all the nodes that are reachable from a node v. If a node v is not interested in topic t, Nodes[v][t] contains an empty set (or null).

For each new candidate edge e=(v,w) to be added to an overlay network, let T(v,w) be the set of topics such that for each topic t in the set T(v,w):
(1) Both nodes v and w are interested in topic t, and
(2) Both nodes v and w are members of two different topic-connected component for topic t, i.e. Nodes[v][t] and Nodes[w][t] are disjoint. In other words, at the subgraph induced by topic t, there is no path between nodes v and w.
   Thus, T(v,w) enumerates the topics for which two connected components are merged by the addition of the edge e=(v,w). For each topic t in the set T(v,w), connected components that are merged by an addition of edge e=(v,w) includes nodes in Nodes[v][t] and nodes in N[w][t]. Thus, after the addition of the edge e, the merged components contains C=Nodes[v][t]+Nodes[w][t] (+means set union).

Thus, a contribution of an edge e=(v,w) to a reduction in the total number of topic-connected components is exactly a size of the set T(v,w) (that is, |T(v,w)|). Once the edge e=(v,w) is added to an overlay network, Nodes[u][t] for each node u in C (the merged components) is updated by setting Nodes[u][t]:=C. (:=is an assignment operator).

At each iteration, the GM algorithm finds an edge that maximizes |T(v,w)|. That is, at each iteration, the GM algorithm finds an edge that includes a highest contribution value; a contribution value of an edge means the number of common topics between two separate components being connected through the edge.

Every edge addition causes a merge of at least two separate topic-connected components (for at least one topic) thus reducing an overall number of topic-connected components by at least one. Whenever an edge with |T(v,w)|>0 (i.e., an edge merging two separate connected components for at least one topic for which there are at least two separate connected components) cannot be found, the GM algorithm stops, because this condition (i.e., there is no edge with |T(v,w)|>0) implies that a subgraph induced by every topic includes a single topic-connected component.

A naïve implementation (e.g., considering every edge and then selecting an edge having a maximum contribution value) of the GM algorithm that searches in each step for a best edge (i.e., an edge maximally reducing the number of topic-connected components for topics) has a running time of O(|V|⁴|T|). Because there are a maximum |V|² edges and searching naively for each edge (e.g., considering every edge and then selecting an edge having a maximum contribution value) takes at most |V|²|T|.

In one embodiment, the GM algorithm uses an auxiliary array LinkContrib, whose elements are sets of edges sorted according to their contribution value to an overlay network. For example, an edge with a highest contribution value is added to an element in the LinkContrib array, where the element has edges with the highest contribution value (e.g., adding an edge with a highest contribution value to LinkContrib[the highest contribution value]). In other words, a set of edges in LinkContrib[i] contains all the edges that reduce by i the total number of topic-connected components. All edges in LinkContrib[i] has i=|T(v,w)| (i.e., i is a contribution value of the edges in LinkContrib[i]).

In one embodiment, the GM algorithm has an index (e.g., HighestContrib) keeping track of the highest element (i.e., an element having a set of edges having a highest contribution value, where I≦the highest contribution value≦|T|) in the array LinkContrib. In this embodiment, when finding an edge having a highest contribution value, an edge from LinkContrib[HighestContrib] (i.e., an element with a set of edges having a highest contribution value) is selected. When there are multiple edges in LinkContrib[HighestContrib], an edge is selected in a deterministic manner (e.g., a lexicographic order). For example, when there are multiple edges in LinkContrib[HighestContrib], an edge with a smallest lexicographic order is chosen. In an alternative embodiment, when there are multiple edges in LinkContrib[HighestContrib], an edge with a largest lexicographic order is chosen. In another embodiment, when there are multiple edges in LinkContrib[HighestContrib], an edge in LinkContrib[HighestContrib] is randomly selected.

Following is a pseudo-code depicting of an initialization phase before executing the GM algorithm:

Algorithm 1 GM Data Structure Initialization

1: for all node v do
2: for all topic t such that Int(v,t) do
3: NODES[v][t] ← {v}
4: for all edge e = (v,w) do
5: contrib ← |{l ∈ T : Int(v,t) [symbol] Int(w,t)}|
6: if contrib > 0 then
7: add e to LINKCONTRIB[contrib]
8: HIGHESTCONTRIB← max(i|LINKCONTRIB[i] not empty)
9: OUTPUTOVERLAYEDGES←

During this initialization phase, nodes, a link contribution array (e.g., LinkContrib) and a highest contribution index (e.g., HighestContrib) are derived: at lines 1-3 of algorithm 1, elements in an array Nodes (i.e., a set of nodes) are initialized to a singleton topic-connected component (i.e., an unconnected node) for every topic. At lines 4-7 of algorithm 1, an initial contribution of each edge (i.e., a size of mutual interest between two different nodes) is calculated. Each edge is allocated to an element of the link contribution array (e.g., LinkContrib) according to the calculated contribution. At line 8 of algorithm 1, an index for a highest element (i.e., an element having a set of edges having a highest contribution value) in the link contribution array (e.g., LinkContrib) is assigned to a highest contribution index (e.g., HighestContrib). In other words, the line 8 of algorithm 1 searches the link contribution array (e.g., LinkContrib) to find a highest element that is not empty in the link contribution array. The edges in the highest element in the link contribution array render a highest reduction in the number of topic-connected components by adding the edges in an overlay network. At line 9 of algorithm 1, a set of overlay edges is initialized to an empty set. The overlay edges are edges connecting the nodes to construct a topic-connected overlay network (i.e., an overlay network having a single connected component for every topic).

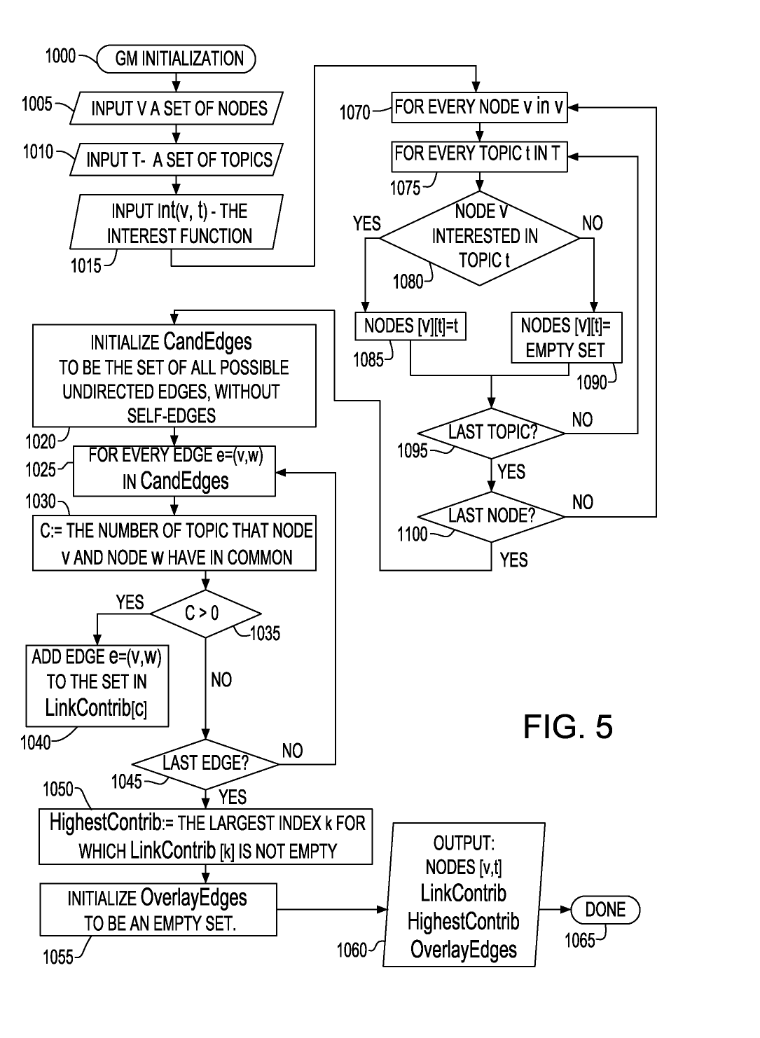

FIG. 5 illustrates a flow chart for an initialization phase (i.e., a phase initializing sets of nodes, a link contribution array, a highest contribution index and a set of overlay edges) of the GM algorithm. At step 1000, an initialization of the GM algorithm is started. In one embodiment, a network administrator invokes the start of the initialization of the GM algorithm. At step 1005, a set of nodes (V) in a pub/sub system is received as an input. At step 1010, a set of topics (T) in the pub/sub system is received as an input. At step 1015, an interest function (e.g., Int(v,t)) is received as an input. In one embodiment, the network administrator performs the steps 1005-1015 manually. In another embodiment, the steps 1005-1015 are performed automatically by a network resource discovery tool (e.g., WhatsUp Gold from Ipswitch, Inc.). Another network resource discovery tool is also discussed in “Using Mobile Agents for Network Resource Discovery in Peer-to-Peer Networks”, Cameron Ross Dunne, 2001, ACM Inc. (hereinafter “Dunne”). Therefore, the whole contents and disclosure of Dunne is incorporated by a reference as if fully set forth herein.

At steps 1070-1080, for every node (v) in a set of nodes (V) and for every topic (t) in a set of topics (T), it is checked whether a node is interested in a topic. At step 1085, when a node is interested in a topic (e.g., a node subscribes a topic), the node is assigned to an element in an array of sets of nodes (e.g., Nodes[v][t]:=v). At step 1090, if the node is not interested in the topic, a corresponding element in the array of sets of nodes becomes an empty set (e.g., Nodes[v][t]:=Ø). At step 1095, it is checked whether all the topics in the set of topics (T) has been processed thorough steps 1075-1095. Steps 1075-1095 are repeated until all the topics in the set of topics (T) are processed by an interest function (e.g., a step 1080). At step 1100, it is checked whether a last node is processed. The steps 1070-1100 are repeated until all topics and all nodes are processed (e.g., all elements in an array Nodes are defined as a singleton connected component or an empty set by considering all pairs of every node and every topic).

At step 1020, a set CandEdges (i.e., a set including all possible edges that can be in an overlay network) is initialized to include all possible undirected edges without self-edges (e.g., an edge connecting a node A and the node A; an edge like a ring (i.e., a starting point of the edge and an ending point of the edge is same)). At steps 1025-1030, for every edge in the set CandEdges, the number of common topics (c) between two different nodes is calculated. In other words, the number of shared topics between two different nodes is calculated by assuming that the two different nodes are connected by adding each edge in the set CandEdges.

At step 1035, it is checked whether the number of common topics (c) is larger than zero. If the number of common topics between two different nodes is larger than zero (e.g., c>0), at step 1040, the edge connecting the two different nodes is added to an element in a link contribution array according to the number of common topics (e.g., the edge is added to a set of edges in LinkContrib[c]). After adding the edge to the link contribution array or if the number of common topics is zero, at step 1045, it is checked whether all the edges in the CandEdges are considered to calculate an initial contribution value of each edge (i.e., the number of common topics being shared between two different nodes by connecting the two different nodes through each edge). Steps 1025-1045 are repeated until all the edges in CandEdges are processed by assigning each edge to an element in the link contribution array according to its contribution value).

Continuing step 1050, a highest contribution index (e.g., HighestContrib) is set to the highest index in the link contribution array, where an element (e.g., an element in the link contribution array) indexed by the highest index is not empty. At step 1055, a set of overlay edges (i.e., edges connecting the nodes to construct a topic-connected overlay network) is initialized to an empty set.

At step 1060, an array of sets of nodes (e.g., Nodes[v][t]), a link contribution array (e.g., LinkContrib), a highest contribution index (e.g., HighestContrib) and a set of overlay edges (e.g., OverlayEdges) are delivered as outputs. The link contribution array includes sets of edges as elements. The elements in the link contribution array are sorted in an order according to contribution values of the sets of edges. The highest contribution index keeps track of a highest element in the link contribution array. At step 1065, the initialization phase is completed.

In one embodiment, the algorithm 1 is implemented as hardware on a reconfigurable hardware (e.g., FPGA (Field Programmable Gate Array) or CPLD (Complex Programmable Logic Device)) using a hardware description language (Verilog, VHDL, Handel-C, or System C). In one embodiment, the algorithm 1 is implemented on a semiconductor chip (e.g., ASIC (Application-Specific Integrated Circuit)) using a semi custom design methodology (i.e., designing a chip using standard cells and a hardware description language).

In one embodiment, the algorithm 1 is implemented as software using a programming language (e.g., C, C++, Java, .NET, etc.). In one embodiment, the algorithm 1 is recorded in a computer recordable medium (e.g., CD (Compact Disk), DVD (Digital Versatile Disc), HDD (Hard Disk Drive)) as an instruction (e.g., machine or assembly language) that is executed by a processor (e.g., Intel® Pentium®, IBM® Power PC®, AMD® Operon®).

In one embodiment, the algorithm 1 is implemented as hardware through a computing device (e.g., a desktop, a laptop, a mainframe, a server, or a workstation) by being executed in the computing device. The computing device comprises, but not limited to include, processor(s), memory(s), display device(s), input/output device(s) and network interface(s).

Following is a pseudo-code for a topic-connected overlay network construction of the GM algorithm.

Algorithm 2 GM Overlay Construction

| | |
|---|---|
| 1: | while HIGHESTCONTRIB> 0 do |
| 2: | e ← some edge (v,w) from LINKCONTRIB[HIGHESTCONTRIB] |
| 3: | OUTPUTOVERLAYEDGES← OUTPUTOVERLAYEDGES∪{e} |
| 4: | delete e from LINKCONTRIB[HIGHESTCONTRIB] |
| 5: | for all topic t such that Int(v,t) [symbol] Int(w,t) do |
| 6: | for all v′ ∈NODES[v][t], w′ ∈NODES[w][t], (v′,w′) ≠ (v,w) do |
| 7: | locate i such that (v′,w′) ∈ LINKCONTRIB[i] |
| 8: | delete (v′,w′) from LINKCONTRIB[i] |
| 9: | if i > 1 then |
| 10: | add (v′,w′) to LINKCONTRIB[i − 1] |
| 11: | new_connected_component_list ← NODES[v][t] ∪ NODES[w][t] |
| 12: | for all u ∈ new_connected_component_list do |
| 13: | NODES[u][t] ← new_connected_component_list |
| 14: | while HIGHESTCONTRIB> 0 and LINKCONTRIB[HIGHESTCONTRIB] is empty do |
| 15: | HIGHESTCONTRIB← HIGHESTCONTRIB−1 |
| 16: | output (V, OUTPUTOVERLAYEDGES) and halt |

The algorithm 2 is executed after executing algorithm 1. The algorithm 2 generates a topic-connected overlay network: at lines 1-4 of the algorithm 2, an edge from a highest element in a link contribution array (i.e., an edge in LinkContrib[HighestContrib]) is removed at a time and then added to a set of overlay edges, as long as the highest element in the link contribution array is not empty set. In one embodiment, the highest element in the link contribution array is indicated by a highest contribution index (e.g., HighestContrib). At lines 5-10 of the algorithm 2, after adding the edge (i.e., an edge in LinkContrib[HighestContrib]) to a set of overlay edges, contributions (i.e., contribution of an edge means the number of common topics that has been disjoint between two separate connected components, which are to be connected with each other by adding the edge) of other edges are recalculated. At line 11 of the algorithm 2, a new connected component is obtained by combining two separate connected components through the edge (e.g., the edge being added to the set of overlay edges at the line 3 of the algorithm 2; e.g., Nodes[v][t] U Nodes[w][t], where Nodes[v][t] refers a connected components for topic t; For example, Nodes[v][t] refers to a connected component comprised of a node 1, a node 2 and an edge between the node 1 and node 2 in FIG. 1B. Nodes[w][t] refers to a connected component comprised of a node 3, a node 6 and an edge between the node 3 and node 6 as shown in FIG. 1B.). At lines 12-13 of the algorithm 2, all combinations of combining the two separate connected components (e.g., Nodes[v][t] and Nodes[w][t]) are considered. The two separate connected components are combined based on a highest contribution that can be achieved by adding an edge (e.g., by adding an edge in LinkContrib[HighestContrib]). In other words, at lines 5-13 of the algorithm 2, after adding an edge (i.e., an edge in LinkContrib[HighestContrib])) to the set of overlay edges and removing the edge from the link contribution array, contribution values of other edges are updated. This update is performed by replacing contribution values of edges that connect the two separate connected components, which have become connected by addition of the edge (i.e., an edge in LinkContrib[HighestContrib]). Sets of nodes (e.g., array Nodes) are then updated to reflect the combined two separated connected components. At lines 14-15 of the algorithm 2, a highest contribution index is updated to keep track of a highest element in the link contribution array that is not empty. In one embodiment, the link contribution array is sorted in descending order according to contribution values of edges. Therefore, every iteration, the highest contribution index is set to a downward (e.g., the highest contribution index is set to the highest contribution index−1). In another embodiment, the link contribution array is sorted in ascending order according to contribution values of edges. Therefore, every iteration, the highest contribution index is set to an upward (e.g., the highest contribution index is set to the highest contribution index+1). After a completion of a loop at the lines 1-15, there is only single connected component for every topic. Once the link contribution array becomes empty sets (e.g. LinkContrib[1] becomes empty set, where 1 refers to a lowest contribution value), the algorithm 2 terminates. When the algorithm 2 terminates (e.g., at line 16 of the algorithm 2), the algorithm 2 generates a single topic-connected overlay network for every topic. In one embodiment, upon completion of the algorithm 2, the algorithm 2 outputs nodes and a set of overlay edges comprising the overlay network, which is topic-connected for every topic in a pub/sub system. The nodes (i.e., nodes in the pub/sub system) are organized in a single connect component for every topic by the outputted set of overlay edges.

In one embodiment, an element in the link contribution array is found in O(1) time (e.g., a constant time), because there is a pointer to element in the link contribution array along with each edge. That is, a data structure representing an edge may include, but is not limited to include, a node (i.e., a node where the edge is connected to), another node (i.e., a node where the edge is connected to), a pointer to an element in the link contribution array and an index of the element of the link contribution array (i.e., an integer variable indicating the contribution value of the edge). A running time of the algorithm 2 is O(|V|²|T|).

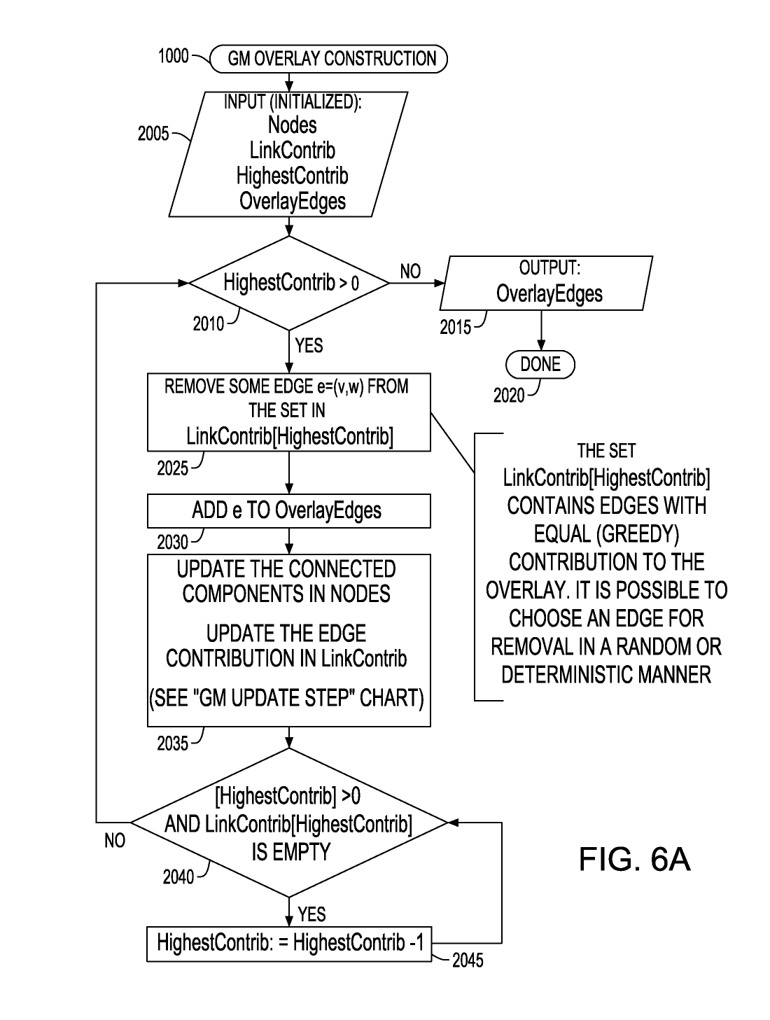

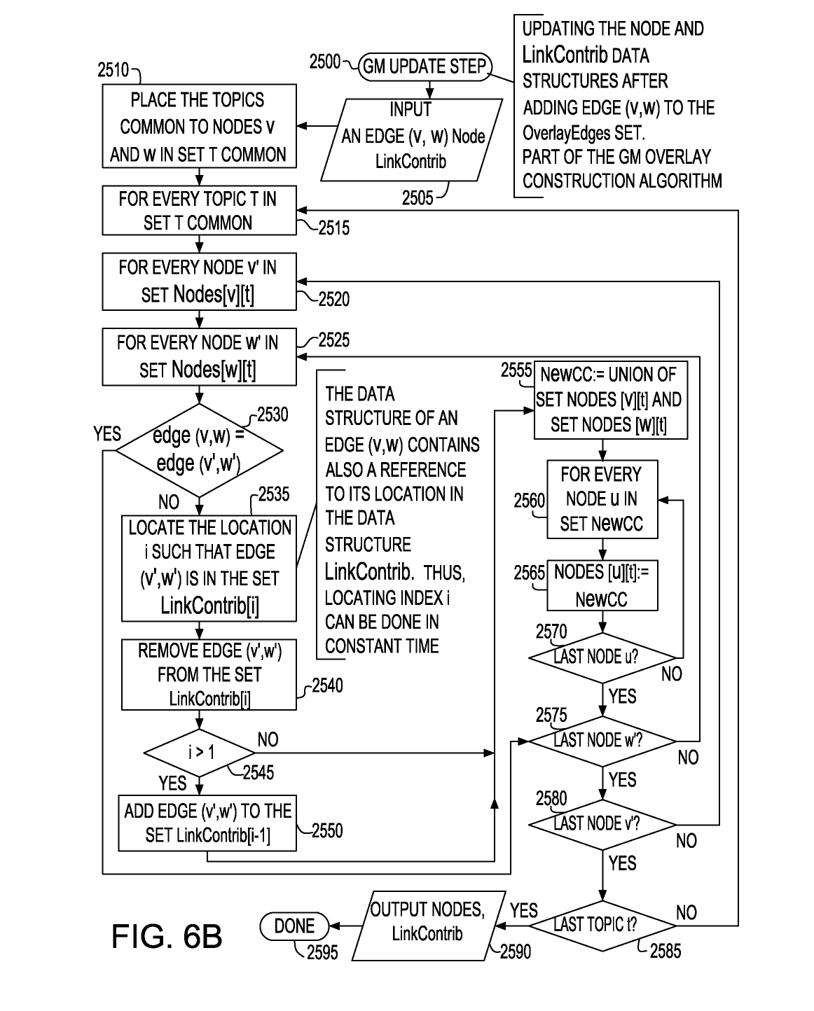

FIG. 6A illustrates a flow chart of an overlay network construction of the GM algorithm. At step 2000, the overlay network construction is initiated by a user (e.g., a network administrator). At step 2005, inputs from the algorithm 1 (i.e., the initialization phase) are received. The inputs comprise, but are not limited to include, sets of nodes, a link contribution array, a highest contribution index and a set of overlay edges. At step 2005, the link contribution array has elements sorted in an order according to contribution values of sets of nodes. The highest contribution index is an index for a highest element in the link contribution array. The set of overlay edges are an empty set.

At step 2010, it is checked whether the highest contribution index (e.g., HighestContrib) is larger than zero. In other words, it is checked whether all the elements in the link contribution array become an empty set. If the highest contribution index is zero, a set of overlay edges is provided to the user. A topic-connected overlay network is constructed based on the set of overlay edges and nodes. The topic-connected overlay network has a single connected component for every topic. At step 2020, the overly network construction is completed.

If the highest contribution index is larger than zero, at step 2025, an edge in the highest element in the link contribution array is removed. An element in the link contribution array contains edges with an equal contribution (i.e., an index of an element in the link contribution array refers to a contribution value of all edges in the element). Therefore, it is allowed to select an edge in the highest element in random (i.e., arbitrary) or a deterministic manner. The deterministic manner means a selection rule that yields a same output every time a same input is applied. For example, ordering edges lexicographically or choosing a first edge in an element in the link contribution array is the deterministic manner.

At step 2030, the removed edge (i.e., an edge removed from the highest element in the link contribution array at step 2025) is added to a set of overlay edges. The set of overlay edges is a set of edges that are used for constructing a topic-connected overlay network. After adding the removed edge to the set of overlay edges, at step 2035, two separate connected components are connected through the removed edge. Contribution values of other edges are updated according to FIG. 6B. Connected components in sets of nodes (e.g., Nodes[v][t]) are updated according to FIG. 6B. (FIG. 6B will be explained in detail later.)

At step 2040, it is checked whether the highest contribution index (e.g., HighestContrib) is larger than zero and whether the highest element (i.e., a highest element in the link contribution array) indicated by the highest contribution index is empty. If the highest contribution index is equal to zero or the highest element indicated by the highest contribution index is not empty, the process returns to step 2010 to repeat steps 2025-2040 or to complete the overlay network construction (e.g., by executing steps 2015-2020). If the highest contribution index is larger than zero and the highest element indicated by the highest contribution index is empty, the highest contribution index is updated (e.g., by assigning the highest contribution index −1 to the highest contribution index).

FIG. 6B illustrates a detailed process of the step 2035 of FIG. 6A. At step 2500, a process for updating sets of nodes, connected components and the link contribution array is initiated, after adding the removed edge to the set of overlay edges (i.e., the step 2030 in FIG. 6A). At step 2505, the removed edge (i.e., an edge removed at step 2025 in FIG. 6A; e.g., an edge e=(v,w)), the link contribution array and sets of nodes having connected components are received as inputs from the step 2030 in FIG. 6A.

At step 2510, a set of topics (e.g., Tcommon) is defined to store common topics between two connected components that are connected by the removed edge (e.g., an edge e=(v,w) that is an edge connecting a node v and a node w). At steps 2515-2530, for every topic t in the set Tcommon, every node v′ that are reachable from a node v for topic t, every node w′ that are reachable from a node w for topic t, it is checked whether an edge (v,w) and an edge (v′,w′) are same. For example, the node v refers to a node 1 in FIG. 1B. The node v′ refers to a node 2 in FIG. 1B. The node w refers to a node 3 in FIG. 1B. The node w′ refers to a node 6 in FIG. 1B. In other words, the node v and node v′ are in a connected component for their common topics. The node w and node w′ are in a connected component for their common topics. If the edge (v′,w′) and the edge (v,w) are same, a step 2575 is processed (the step 2575 is explained later in detail). If the edge (v′,w′) and the edge (v,w) are not same, a step 2535 is processed.

At step 2535, an element having the edge (v′,w′) is located in the link contribution array. In one embodiment, a data structure of an edge includes an index of an element in the link contribution array where the edge is stored. Therefore, the element having the edge (v′,w′) can be located in a constant time (i.e., the element can be located at a fixed time regardless sizes of inputs).

At step 2540, the edge (v′, w′) is removed from the link contribution array. At step 2545, it is checked whether the index (i) of the element having the removed edge (v′, w′) is larger than one. In other words, it is checked whether the removed edge(v′,w′) had a contribution value larger than one. If the index (i) of the element having the removed edge is equal to 1 or 0, a step 2555 is processed (the step 2555 is explained later in detail). If the index of the element having the removed edge is larger than 1, a step 2550 is processed.

Then continuing step 2550, the edge (v′,w′) is added to a set of edges in the link contribution array indicated by the index (i)−1 (e.g., adding the edge (v′,w′) to a set of edges in LinkContrib[i−1]). At step 2555, a new connected component is obtained by combining a connected component (e.g., Nodes[v][t]: a connected component comprising all nodes that are reachable from a node v for a topic t) and another connected component (e.g., Nodes[w][t]: a connected component comprising all nodes that are reachable from a node w for a topic t).

At steps 2560-2570, every node in the new connected component is assigned to a set of nodes (e.g., Nodes[u][t]:=a new connected component). At step 2575, it is checked whether all the nodes in a connected component comprising a set of nodes reachable from a node w for a topic t has been considered. If all the nodes in the connected component (e.g., all nodes in Nodes[w][t]) has not been processed, steps 2525-2575 are processed again to recalculate contribution values of unprocessed edge(s). If all the nodes in the connected component (e.g., all nodes in Nodes[w][t]) has been processed through steps 2525-2575, a step 2580 is performed. At step 2580, it is checked whether all the nodes in a connected component comprising a set of nodes reachable from a node v for a topic t has been processed. If all the nodes in the connected component (e.g., all nodes in Nodes[v][t]) has not been processed, steps 2520-2580 are repeated to recalculate contribution values of unprocessed edge(s). If all the nodes in the connected component (e.g., all nodes in Nodes[v][t]) has been processed through steps 2520-2580, a step 2585 is performed. At step 2585, it is checked whether all the topics in the set of topics (e.g., Tcommon) has been processed. If all the topics in the set of topics have not been processed, steps 2515-2585 are repeated to construct new connected components by combining two separate connected components for all the topics in the set of topics. If all the topics in the set of topics (e.g., Tcommon) have been processed though steps 2515-2585, a step 2590 is performed. At step 2590, the link contribution array and sets of nodes including the new connected components (e.g., a connected component created at step 2555) are outputted. The link contribution array at the step 2590 has recalculated contribution values of edges. In one embodiment, after the step 2590 is executed, the step 2040 of FIG. 6A is executed. At step 2595, an update of connected components in sets of nodes and an update of contribution values in the link contribution array are completed.

In one embodiment, the algorithm 2 is implemented as hardware on a reconfigurable hardware (e.g., FPGA (Field Programmable Gate Array) or CPLD (Complex Programmable Logic Device)) using a hardware description language (Verilog, VHDL, Handel-C, or System C). In one embodiment, the algorithm 2 is implemented on a semiconductor chip (e.g., ASIC (Application-Specific Integrated Circuit)) using a semi custom design methodology (i.e., designing a chip using standard cells and a hardware description language).

In one embodiment, the algorithm 2 is implemented as software using a programming language (e.g., C, C++, Java, .NET, etc.). In one embodiment, the algorithm 2 is recorded in a computer recordable medium (e.g., CD (Compact Disk), DVD (Digital Versatile Disc), HDD (Hard Disk Drive)) as an instruction (e.g., machine language or assembly language) that is executed by a processor (e.g., Intel® Pentium®, IBM® Power PC®, AMD® Operon®).

In one embodiment, the algorithm 2 is implemented as hardware through a computing device (e.g., a desktop, a laptop, a mainframe, a server, or a workstation) by being executed in the computing device. The computing device comprises, but not limited to include, processor(s), memory(s), display device(s), input/output device(s) and network interface(s).

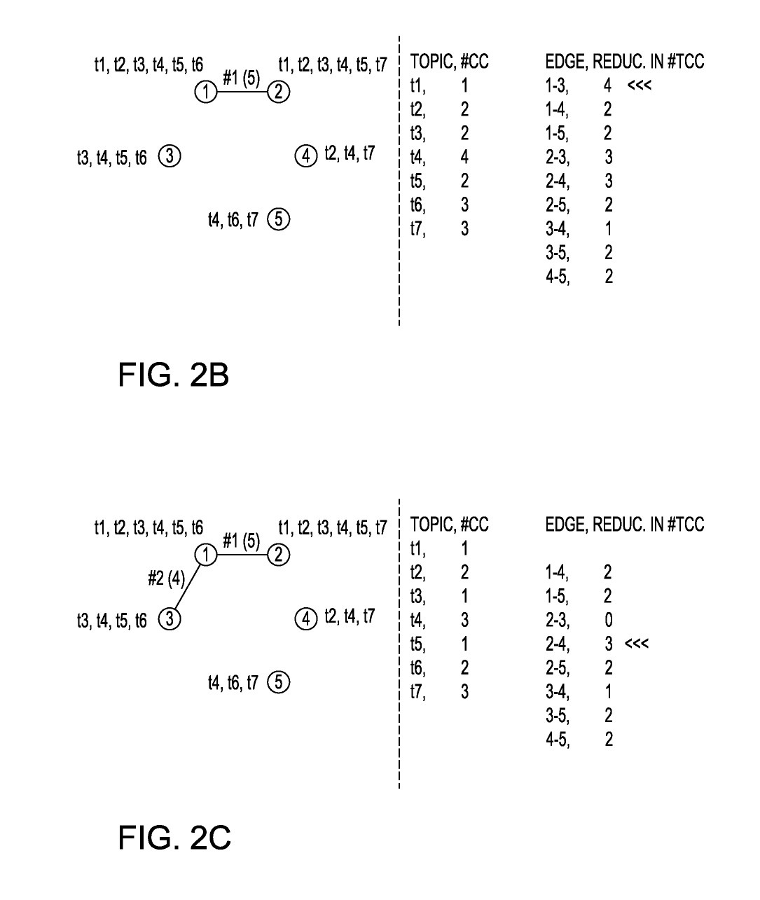

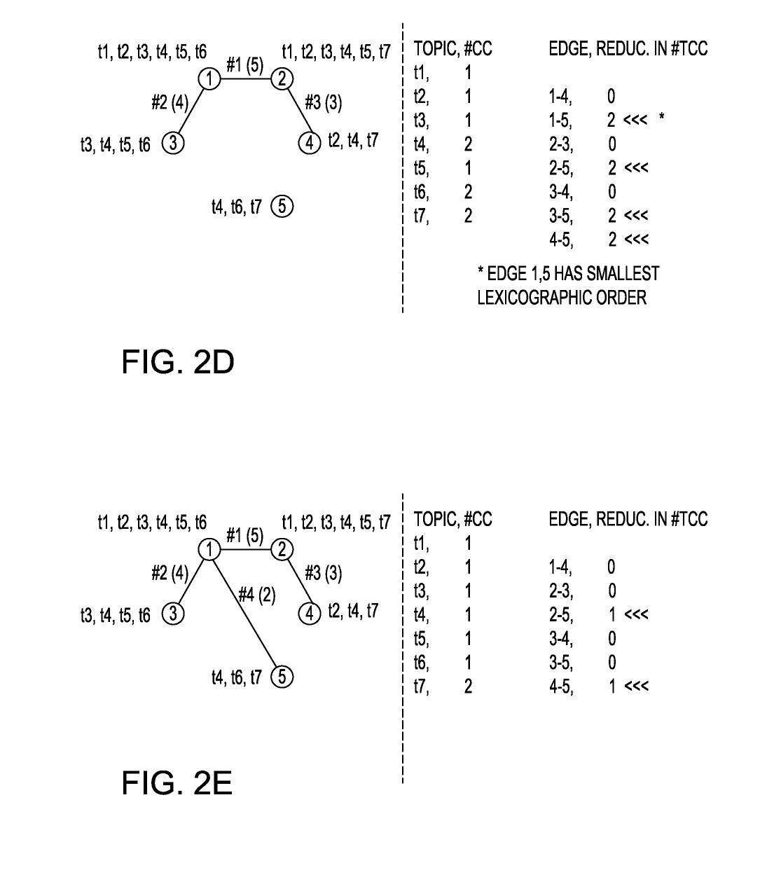

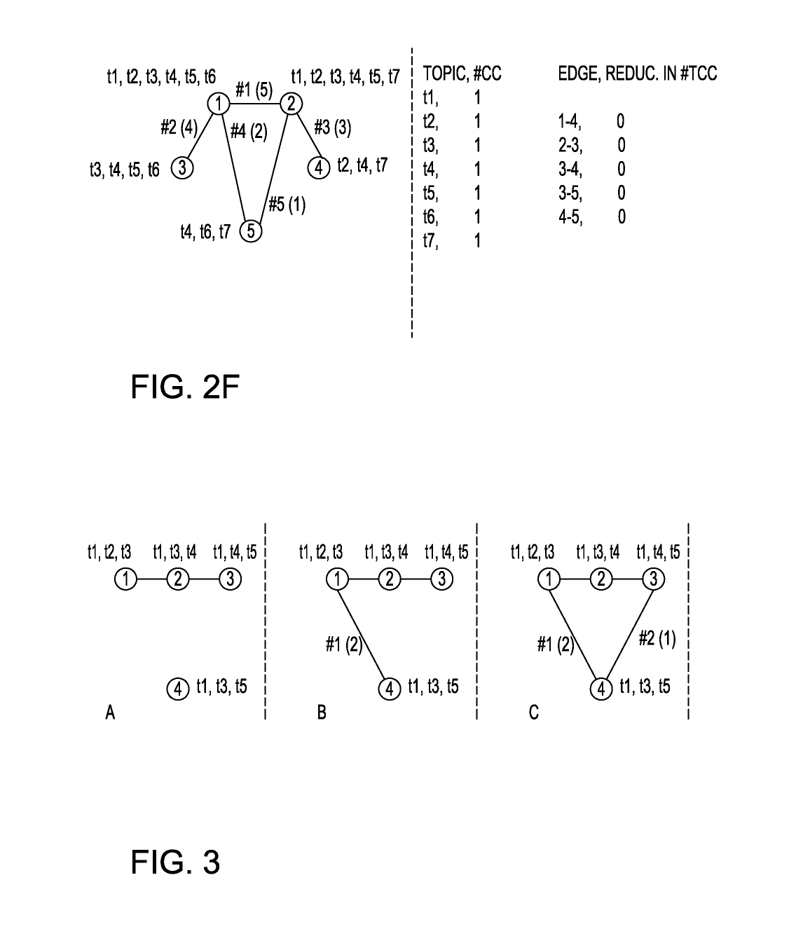

FIGS. 2A-2F illustrate an example of constructing an overlay network in a pub/sub system, when nodes and subscribing topics of the nodes are given. A left side of FIG. 2A shows there are six nodes (e.g., a node 1, a node 2, a node 3, a node 4, a node 5 and a node 6). The node 1 is interested in (e.g., subscribes) six topics (e.g., topics t1, t2, t3, t4, t5 and t6). The node 2 is interested in six topics (e.g., topics t1, t2, t3, t4, t5 and t7). The node 3 is interested in four topics (e.g., topics t3, t4, t5 and t6). The node 4 is interested in three topics (e.g., topics t2, t4 and t7). The node S is interested in three topics (e.g., topics t4, t6 and t7).

A right side of FIG. 2A shows two tables. A left table comprises topics and the number of connected components (CC) in a subgraph induced by each topic. For example, for a topic t1, there are currently two connected components (i.e., an unconnected node is considered as a singleton connected component. So, there are two connected components (e.g., a node 1 and node 2)). For a topic t2, there are currently three connected components (e.g., a node 1, node 2, and node 4). A right table on the left side of FIG. 2A comprises edges and reductions in the number of topic-connected components caused by additions of edges. The reduction in the number of topic-connected components means the number of topic for which two topic-connected components are merged, when a corresponding edge is added. For example, for an edge connecting a node 1 and a node 2, the reduction in the number of topic-connected components (TCC) is five (e.g., topics t1, t2, t3, t4 and t5). For an edge between a node 1 and a node 3, the reduction in the number of topic-connected components is 4 (e.g., topics t3, t4, t5 and t6). In one embodiment, the edges and their contribution values (i.e., the reductions in the number of topic-connected components) in the right table are stored in a link contribution array in a sorted order. For example, an edge between a node 1 and a node 2 is stored in the sixth element of the link contribution array (e.g., LinkContrib[5]). In this example, the sixth element of the link contribution array is the highest element (i.e., an element having a set of edges having a highest contribution value). In one embodiment, there is a highest contribution index, which indicates the highest element in the link contribution array. In this example, at this stage (e.g., FIG. 2A), the highest contribution index has an integer value 5. In this example, at this stage (e.g., FIG. 2A), the link contribution array has 6 elements (e.g., LinkContrib[5] including an edge (1,2), LinkContrib[4] including an edge (1,3), LinkContrib[3] including an edge (2,3) and an edge (2,4), LinkContrib[2] including an edge (1,4), an edge (1,5), an edge (2,5), an edge (3,5) and an edge (4,5), LinkContrib[1] including an edge (3,4) and LinkContrib[0] including no edge (i.e., an empty set)). In one embodiment, LinkContrib[1] is the lowest element in the link contribution array. In another embodiment, LinkContrib[0] is the lowest element in the link contribution array. In this embodiment, the LinkContrib[0] has always an empty set. In FIG. 2B, an edge between a node 1 and a node 2 (e.g., an edge (1,2)) is added to a set of overlay edges, because the edge (1,2) has a highest contribution value (i.e., the edge (1,2)'s reduction in the topic-connected component was 5). At the same time, the edge (1,2) is removed in the link contribution array. Accordingly, the sixth element in the link contribution array (e.g., LinkContrib[5]) becomes an empty set. In this exemplary embodiment, an edge being added to the set of overlay edges are indicated by #N (M), where N indicates a turn on which the edge is added to the set of overlay edges and M indicates the reduction in TCC of the edge. For example, the edge (1,2) is indicated by #1 (5) at left side of FIG. 2B, after the edge is added to the set of overlay edges. #1 (5) on the edge (1,2) means the edge (1,2) is a first edge added to the set of overlay edges and its reduction in TCC is 5.

After the edge (1,2) is added to the set of overlay edges, connected components for each topic (e.g., a left table on a right side of FIG. 2B) is updated to reflect that a node 1 and a node 2 becomes a connected component. For example, for a topic t1, there is currently one connected component (e.g., a connected component comprising a node 1, a node 2 and an edge (1,2)). For a topic t2, there are currently two connected components (e.g., a connected component comprising a node 1 and a node 2, a singleton connected component comprising a node 4).

After the edge (1,2) is added to the set of overly edges, contribution values of other edges are updated by recalculating the reduction in topic-connected components of the edges. The right table on a right side of FIG. 2B shows the update of the contribution values of other edges. In this example, at this stage (e.g., FIG. 2B), there is no change from FIG. 2A (except an edge (1,2) has been removed from consideration), because contribution values of other edges are not affected by the addition of the edge (1,2). For example, an edge (1,3) still has a contribution value 4 (e.g., topics t3, t4, t5 and t6). An edge (2,3) has a contribution value 3 (e.g., t3, t4 and t5). After contribution values of other edges are updated, the highest contribution index in updated to indicate a currently highest element in the link contribution index. The sixth element in the link contribution array becomes an empty set. The highest contribution index now indicates a fifth element of the link contribution index (e.g., LinkContrib[4]).

In FIG. 2C, an edge between a node 1 and a node 3 (e.g., an edge (1,3)) is added to a set of overlay edges, because the edge (1,3) has a highest contribution value (i.e., the edge (1,3)'s reduction in the topic-connected component was 4). At the same, the edge (1,3) is removed in the link contribution array. Accordingly, the fifth element in the link contribution array becomes an empty set. The added edge (1,3) is indicated by #2 (4) at left side of FIG. 2C, after the edge is added to the set of overlay edges. #2 (4) on the edge (1,2) means the edge (1,2) is a second edge added to the set of overlay edges and its reduction in TCC is 4.

After the edge (1,3) is added to the set of overlay edges, connected components for each topic (e.g., a left table on a right side of FIG. 2C) is updated to reflect that a node 1, a node 2 and a node 3 become a connected component for topics t3, t4 and t5. A node 1 and a node 3 become a connected component for topic t6. Accordingly, the number of connected components per each topic is updated as shown in a left table on right side of FIG. 2C. For example, for a topic t3, there is currently one connected component (e.g., a connected component comprising the node 1, the node 2, the node 3, the edge (1,2) and the edge (1,3)). That means an overlay network shown in a left side of FIG. 2C is topic-connected for a topic t3. (The overlay network shown in left side of FIG. 2C is also topic-connected for topics t1 and t5). For a topic t2, there are currently two connected components (e.g., a connected component comprising a node 1 and a node 2, a singleton connected component comprising a node 4).

After the edge (1,3) is added to the set of overly edges, contribution values of other edges are updated by recalculating the reduction in topic-connected components (TCC) of the edges. The right table on a right side of FIG. 2C shows the update of the contribution values of other edges. In one embodiment, the recalculation of the reduction in TCC are performed on edges that connect the connected components that have become connected due to the addition of the edge (e.g., edge (1,3)). For example, in this example, at this stage (e.g., FIG. 2C), an edge (2,3) is an only edge that requires the recalculation of TCC, because the edge (2,3) connects two previously separate connected components (e.g., a connected component comprising a node 1 and a node 2, a singleton connected component comprising a node 3) that have become connected due to an addition of an edge (1,3). Therefore, an edge (1,4) still has a contribution value 2 (e.g., topics t2 and t4). An edge (2,3) has a contribution value 0 (e.g., there is no need to add an edge (2,3), because a node 2 and a node 3 becomes a connected component for topics t3, t4 and t5 through edges (1,2) and (1,3)). After contribution values of other edges are updated, the highest contribution index in updated to indicate a currently highest element in the link contribution index. The fifth element in the link contribution array becomes an empty set. The highest contribution index now indicates a fourth element of the link contribution index (e.g., LinkContrib[3]).

In FIG. 2D, an edge between a node 2 and a node 4 (e.g., an edge (2,4)) is added to the set of overlay edges, because the edge (2,4) has a highest contribution value (i.e., the edge (2,4)'s reduction in the topic-connected component was 3). At the same, the edge (2,4) is removed in the link contribution array. Accordingly, the fourth element in the link contribution array (e.g., LinkContrib[3]) becomes an empty set. The added edge (2,4) is indicated by #3 (3) at left side of FIG. 2D, after the edge is added to the set of overlay edges. The #3 (3) on the edge (2,4) means the edge (2,4) is a third edge added to the set of overlay edges and its reduction in TCC is 3.

After the edge (2,4) is added to the set of overlay edges, connected components for each topic (e.g., a left table on a right side of FIG. 2D) is updated to reflect that a node 1, a node 2, a node 3 and a node 4 become a connected component for a topic t4. A node 1, a node 2, and a node 4 become a connected component for a topic t2. A node 2 and a node 4 become a connected component for a topic t7. Accordingly, the number of connected components per each topic is updated as shown in a left table on right side of FIG. 2D. The left table on right side of FIG. 2D indicates, an overlay network shown in a left side of FIG. 2D is topic-connected to a topic t1, t2, t3 and t5. For a topic t4, there are currently two connected components (e.g., a connected component comprising a node 1, a node 2, a node 3 and a node 4, a singleton connected component comprising a node 5). For a topic t6, there are currently two connected components (e.g., a connected component comprising a node 1 and a node 3, a singleton connected component comprising a node 5). For a topic t7, there are currently two connected components (e.g., a connected component comprising a node 2 and a node 4, a singleton connected component comprising a node 5).

After the edge (2,4) is added to the set of overly edges, contribution values of other edges are updated by recalculating the reduction in topic-connected components (TCC) of the edges. The right table on a right side of FIG. 2D shows the update of the contribution values of other edges. In one embodiment, the recalculation of the reduction in TCC are performed on edges that connect the connected components that have become connected due to the addition of the edge (e.g., edge (2,4)). For example, in this example, at this stage (e.g., FIG. 2D), edges (1,4) and (3,4) are edges that requires the recalculation of TCC, because the edges (1,4) and (3,4) connect two previously separate connected components (e.g., a connected component comprising a node 1, a node 2 and a node 3, a singleton connected component comprising a node 4) that have become connected due to an addition of an edge (2,4). Therefore, an edge (1,5) still has a contribution value 2 (e.g., topics t4 and t6). An edge (1,4) has a contribution value 0 (e.g., there is no need to add an edge (1,4), because a node 1 and a node 4 became a connected component for topics t2 and t4 through edges (1,2) and (2,4)). An edge (3,4) has a contribution value 0 (e.g., there is no need to add an edge (3,4), because a node 3 and a node 4 became a connected component for a topic t4 through edges (1,2), (1,3) and (2,4)). After contribution values of other edges are updated, the highest contribution index is updated to indicate a currently highest element in the link contribution index. The fourth element in the link contribution array (e.g., LinkContrib[3]) becomes an empty set. The highest contribution index now indicates a third element of the link contribution index (e.g., LinkContrib[2]).

When choosing a next edge added to the set of overlay edges, the highest element in the link contribution array can have multiple edges (e.g., In FIG. 2D, edges (1,5), (2,5), (3,5) and (4,5) have a contribution value 2). Then, in one embodiment, an edge in the highest element in the link contribution array is selected in a deterministic way (e.g., a lexicographical order). In another embodiment, an edge in the highest element in the link contribution array is selected randomly.

In FIG. 2E, an edge between a node 1 and a node 5 (e.g., an edge (1,5)) is added to a set of overlay edges, because the edge (1,5) has a highest contribution value (i.e., the edge (1,5)'s reduction in the topic-connected component was 2) and has a smallest lexicographical order. At the same, the edge (1,5) is removed in the link contribution array. The added edge (1,5) is indicated by #4 (2) at left side of FIG. 2E, after the edge is added to the set of overlay edges. The #4 (2) on the edge (1,5) means the edge (1,5) is a fourth edge added to the set of overlay edges and its reduction in TCC is 2.

After the edge (1,5) is added to the set of overlay edges, connected components for each topic (e.g., a left table on a right side of FIG. 2E) is updated to reflect that a node 1, a node 2, a node 3, a node 4 and a node 5 become a connected component for a topic t4. A node 1, a node 3 and a node 5 become a connected component for a topic t6. Accordingly, the number of connected components per each topic is updated as shown in a left table on right side of FIG. 2E. The left table on right side of FIG. 2E indicates, an overlay network shown in a left side of FIG. 2E is topic-connected for topics t1-t6 (i.e., there is a single connected component for topics t1-t6). For a topic t7, there are currently two connected components (e.g., a connected component comprising a node 2 and a node 4, a node 7).

After the edge (1,5) is added to the set of overly edges, contribution values of other edges are updated by recalculating the reduction in topic-connected components (TCC) of the edges. The right table on a right side of FIG. 2E shows the update of the contribution values of other edges. In one embodiment, the recalculation of the reduction in TCC are performed on edges that connect the connected components that have become connected due to the addition of the edge (e.g., edge (1,5)). For example, in this example, at this stage (e.g., FIG. 2E), edges (2,5), (3,5) and (4,5) are edges that requires the recalculation of TCC, because the edges (2,5), (3,5) and (4,5) connect two previously separate connected components (e.g., a connected component comprising a node 1, a node 2, a node 3 and a node 4, a singleton connected component comprising a node 5) that have become connected due to an addition of an edge (1,5). Therefore, an edge (2,5) has a contribution value 1 (e.g., a topic t7; there are two separate topic connected components for the topic t7 which can be combined by adding the edge (2,5)). An edge (3,5) becomes a contribution value 0 (e.g., there is no need to add an edge (3,5), because a node 3 and a node 5 became a connected component for topics t4 and t6 through edges (1,3) and (1,5)). An edge (4,5) has a contribution value 1 (e.g., a topic t7; there are two separate topic connected components for the topic t7 which can be combined by adding the edge (4,5)). After contribution values of other edges are updated, the highest contribution index is updated to indicate a currently highest element in the link contribution index. The third element (e.g., LinkContrib[2]) in the link contribution array becomes an empty set. The highest contribution index now indicates a second element of the link contribution index (e.g., LinkContrib[1]).

In FIG. 2F, an edge between a node 2 and a node 5 (e.g., an edge (2,5)) is added to a set of overlay edges, because the edge (2,5) has a highest contribution value (i.e., the edge (2,5)'s reduction in TCC was 1) and has a smallest lexicographical order. At the same, the edge (2,5) is removed from the link contribution array. The added edge (2,5) is indicated by #5 (1) at left side of FIG. 2F, after the edge is added to the set of overlay edges. The #5 (1) on the edge (2,5) means the edge (2,5) is a fifth edge added to the set of overlay edges and its reduction in TCC is 1.

After the edge (2,5) is added to the set of overlay edges, connected components for each topic (e.g., a left table on a right side of FIG. 2F) is updated to reflect that a node 2, a node 4 and a node 5 become a connected component for a topic t7. Accordingly, the number of connected components per each topic is updated as shown in a left table on right side of FIG. 2F. The left table on right side of FIG. 2F indicates, an overlay network shown in a left side of FIG. 2F is topic-connected to a topic t1-t7 (i.e., there is a single connected component for topics t1-t7). Therefore, the overlay network in FIG. 2F is a single connected component for all topics (e.g., topics t1-t7). Finally, a single topic-connected overlay network (e.g., FIG. 2F) is constructed.

After the edge (2,5) is added to the set of overly edges, contribution values of other edges are updated by recalculating the reduction in topic-connected components (TCC) of the edges. The right table on a right side of FIG. 2F shows an update of the contribution values of other edges. In one embodiment, the recalculation of the reduction in TCC are performed on edges that connect the connected components that have become connected due to the addition of the edge (e.g., edge (2,5)). For example, in this example, at this stage (e.g., FIG. 2F), an edge (4,5) is the edge that requires the recalculation of TCC, because the edge (4,5) connects two previously separate connected components (e.g., a connected component comprising a node 2 and a node 4, a node 7) that have become connected due to an addition of an edge (2,5). Therefore, an edge (4,5) has a contribution value 0 (e.g., there is no need to add an edge (4,5), because a node 4 and a node 5 became a connected component for topics t4 and t7 through edges (2,4) and (2,5)). After contribution values of other edges are updated, all elements in the link contribution array become empty sets (i.e., there is no edge having a contribution value larger than zero). The highest contribution index now indicates a first element of the link contribution index (e.g., LinkContrib[0]). When all elements in the link contribution array become empty sets, constructing an overlay network is completed. The constructed overlay network (e.g., a left side of FIG. 2F) has a single topic-connected component for all the topics.

In one exemplary embodiment, the left side of FIG. 2A is provided to steps 1000-1015 of FIG. 5 as inputs. The two tables on the right side of FIG. 2A are obtained by executing steps 1020-1100 of FIG. 5. FIG. 2A are provided as inputs to step 2005 of FIG. 6A. FIG. 2B is obtained after first executing steps 2010-2045 of FIG. 6A. FIGS. 2C-2F are obtained at iterations of steps 2010-2045 of FIG. 6A (e.g., a second execution of steps 2010-2045 of FIG. 6A generates FIG. 2C).

A Greedy Join (GJ) algorithm is an algorithm that takes an already existing topic-connected overlay network as an input and adds a new node to the overlay network without changing any of the existing edges. The GJ algorithm adds edges between a new node and existing nodes, one edge at a time. As in GM algorithm, each newly added edge merges previously disjoint connected component for a largest number of common topics. The following is a pseudo-code of an initialization phase (e.g., initializing sets of nodes, a link contribution array, a highest contribution index, etc.) of the GJ algorithm.

Algorithm 3 GJ Data Structure initialization

| | |
|---|---|
| 1: | Node to w ∉ V joining an existing topic-connected overlay G(V,E) |
| 2: | OUTPUTOVERLAYEDGES← E |
| 3: | HIGHESTCONTRIB = 0; |
| 4: | ∀i > 0, LINKCONTRIB[i] = |
| 5: | NODES[v][t] = {u ∈ V : Int(u,t) [symbol] Int(v,t)} |
| 6: | for all topic t such that Int(w,t) do |
| 7: | NODES[w][t] ← {w} |
| 8: | for all node v ∈ V do |
| 9: | contrib ← \|{t ∈ T : Int(v,t) [symbol] Int(w,t)}\| |
| 10: | If contrib > 0 then |
| 11: | add e = (w,v) to LINKCONTRIB[contrib] |
| 12: | HIGHESTCONTRIB← max(i\|LINKCONTRIB[i] not empty) |

The GJ algorithm is essentially same as the GM algorithm, except for the initialization phase. Algorithm 3 illustrates the initialization phase for the GJ algorithm. At line 1 of the algorithm 3, it is assumed that a node w that is not in an existing overlay network G(V,E) is joining the overlay network. Lines 2-5 of the algorithm 3 assume that data structures (e.g., a set of overlay edges, a highest contribution index, and/or a link contribution array) are consistent with a termination state of the GM algorithm that created a topic-connected overlay network. That is, at lines 2-5 of the algorithm 3, a set of overlay edges contains all the edges in the overlay network G. There is a single topic-connected component in an induced subgraph for all topics (e.g., Nodes[v][t] contains a single topic-connected component induced by a topic t). The highest contribution index is set to 0. The link contribution array is empty. An operator ̂ at line 5 of algorithm 3 means a logical “AND”. That is, Int(v,t)̂it(w,t) means (Int(v,t)=true AND Invt(w,t)true), which evaluates “true” for a topic t that is of interest to both a node v and a node w.

Lines 6-7 of the algorithm 3 extend sets of nodes (e.g., array Nodes) by adding a row (e.g., Nodes[w][t]) for the joining node (e.g., a node w) and set the joining node as a singleton connected component in all the topics that the joining node is interested in. At lines 8-11 of the algorithm 3, a contribution value of every edge from the joining node to every other node is calculated. Initial contribution value of each edge from the joining node to every other node is equal to the size of mutual interest (e.g., the number of common topics) between two nodes (e.g., a node w and another node). Each edge is added to the link contribution array according to the calculated contribution value.

Line 12 of the algorithm 3 searches the link contribution array to find a highest element that is not empty. The highest contribution index is set to indicate the highest element in the link contribution array. After the line 12, the algorithm 2 (i.e., GM algorithm) is executed until it stops.

In one embodiment, the algorithm 3 is implemented as hardware on a reconfigurable hardware (e.g., FPGA (Field Programmable Gate Array) or CPLD (Complex Programmable Logic Device)) using a hardware description language (Verilog, VHDL, Handel-C, or System C). In one embodiment, the algorithm 3 is implemented on a semiconductor chip (e.g., ASIC (Application-Specific Integrated Circuit)) using a semi custom design methodology (i.e., designing a chip using standard cells and a hardware description language).

In one embodiment, the algorithm 3 is implemented as software using a programming language (e.g., C, C++, Java, .NET, etc.). In one embodiment, the algorithm 3 is recorded in a computer recordable medium (e.g., CD (Compact Disk), DVD (Digital Versatile Disc), HDD (Hard Disk Drive)) as an instruction (e.g., machine language or assembly language) that is executed by a processor (e.g., Intel® Pentium®, IBM® Power PC®, AMD® Operon®).

In one embodiment, the algorithm 3 is implemented as hardware through a computing device (e.g., a desktop, a laptop, a mainframe, a server, or a workstation) by being executed in the computing device. The computing device comprises, but not limited to include, processor(s), memory(s), display device(s), input/output device(s) and network interface(s).

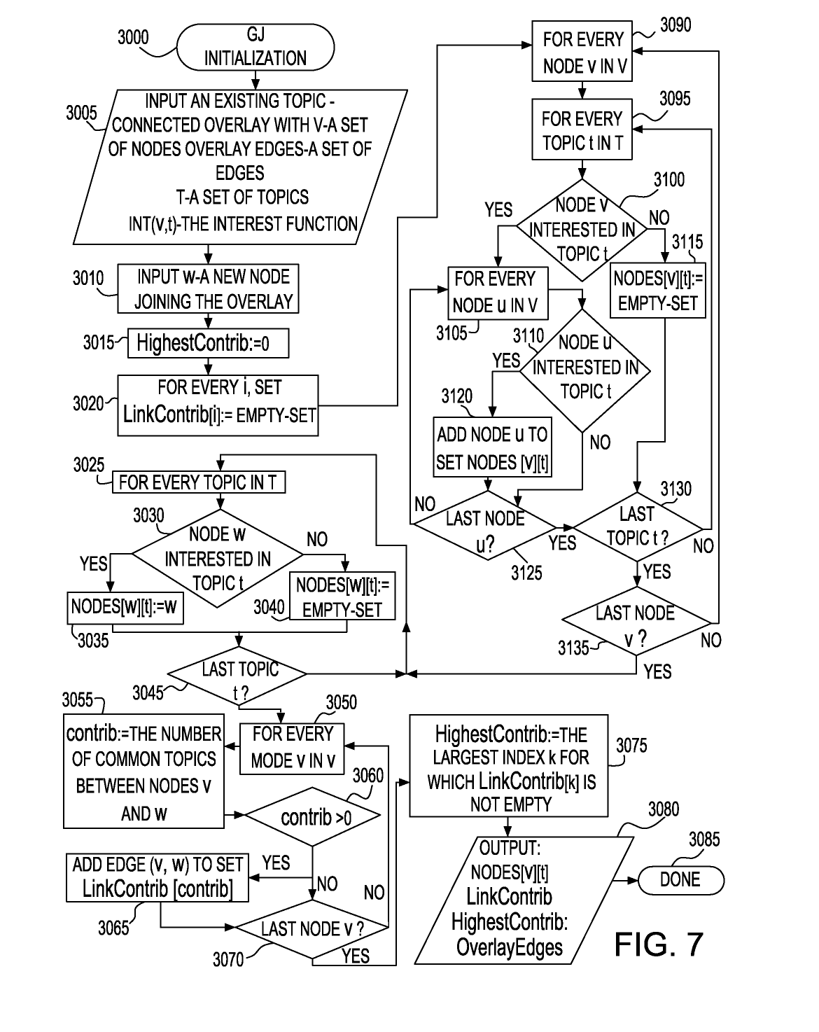

FIG. 7 illustrates a flow chart for an initialization phase of the GJ algorithm. At step 3000, the initialization phase is started by a user (e.g., a network administrator). At step 3050, an existing topic-connected overlay network is received as an input. In one embodiment, the existing topic-connected overlay network has information about a set of nodes in the overlay network, a set of overlay edges (e.g., edges in the overlay network), a set of topics in the overlay network and an interest function (e.g., Int(v,t): a Boolean function that maps a node v and a topic t to either true or false, Int(v,t) is true if and only if node v is interested in a topic t). At step 3010, a new node joining the overlay network is received (e.g., a node w).

At step 3015, a highest contribution index is initialized to zero. At step 3020, all the elements in the link contribution array is set to empty sets. The process proceeds to steps 3090-3105/3115, where for every node v in a set of nodes V and every topic t in a set of topics T, it is evaluated whether a node v is not interested in a topic t. At step 3115, if the node v is not interested in the topic t, Nodes[v] [t] (i.e., a set of nodes that are reachable from a node v for a topic t) is set to an empty set. At step 3105, if a node v is interested in a topic t, steps 3105-3135 are processed. At steps 3105-3110, for every node u in the set of nodes V, it is evaluated whether a node u is interested in a topic t. If the node u is interested in the topic t, at step 3120, the node u is added to Nodes[v][t]. After adding the node u to Nodes[v][t] or if the node u is not interested in the topic t, at step 3125, it is evaluated whether all the nodes in the set of nodes V has been evaluated through steps 3105-3125. Steps 3105-3125 are repeated until all the nodes in the set of nodes V has been evaluated to check whether each node is interested in a topic t. At step 3130, it is checked whether all the topics in the set of topics T has been evaluated through steps 3095-3130. Steps 3095-3130 are repeated until all the topics in the set of topics T has been evaluated in an interest function (e.g., e.g., step 3100 or step 3110). At step 3135, it is evaluated whether all the nodes in the set of nodes V have been evaluated through steps 3090-3135. Steps 3090-3135 are repeated until all the nodes in the set of nodes V has been evaluated to check whether each node is interested in a topic t.

From step 3135, the process proceeds to steps 3025-3030, for every topic t in a set of topics T, it is checked whether a new node w is interested in a topic t. If the new node is not interested in the topic t, at step 3040, Nodes[w][t] (i.e., a set of nodes that are reachable from a node w for a topic t) is set to an empty set. If the new node w is interested in the topic t, at step 3035, Nodes [w][t] (i.e., a set of nodes that are reachable from a node w for a topic t) is set to a singleton connected component comprising the new node w. At step 3045, it is evaluated whether all the topics in the set of topics T have been considered through steps 3025-3045. Steps 3025-3045 are repeated until an interest function (e.g., the step 3030) is evaluated for every topic in the set of topics T and the new node w.

Proceeding to step 3055 from step 3045, for every node in the set of nodes V, a contribution value of an edge between the new node w and every other node is calculated. At step 3060, it is evaluated whether the calculated contribution value (e.g., contrib) is larger than zero (e.g., whether there is at least one common topic between the new node w and every other node). If the calculated contribution value is larger than zero, a corresponding edge is stored in an element in the link contribution array according to the calculated contribution value (e.g., adding the corresponding edge to LinkContrib[contrib]). At step 3070, it is checked whether contribution values of all the edges between the new node w and every other edge have been calculated. Steps 3050-3070 are repeated until contribution values of all the edges between the new node w and every other edge have been calculated. At step 3075, the link contribution array is searched to find a highest element that is not empty. The highest contribution index is set to the highest element in the link contribution array. At step 3080, a set of nodes that are reachable from a node v for a topic t (e.g., Nodes[v][t]), the link contribution array, the highest contribution index and a set of overlay edges are provided as outputs. In one embodiment, these outputs are provided to algorithm 2 as inputs. At step 3085, the initialization phase of the GJ algorithm is completed.

FIG. 3 illustrates a new node (e.g., a node 4) is joining an existing topic-connected overlay network (e.g., a connected component comprising a node 1, a node 2, a node 3, an edge (1,2) and an edge (2,3)). FIG. 3A illustrates an initial condition before there is an edge between the new node (e.g. a node 4) and other nodes. A node 1 is interested in topics t1, t2 and t3. A node 2 is interested in topics t1, t3 and t4. A node 3 is interested in topics t1, t4 and t5. A new node 4 is interested in topics t1, t3 and t5. The node 1, the node 2, the node 3, the edge (1,2) and the edge (2,3) constructs a single topic-connected overlay network for topics t1, t2, t3, t4 and t5, before a new node 4 wants to join the overlay network. A set of overlay edges includes edges (1,2) and (1,3), before adding an edge between a new node 4 and other nodes. A link contribution array has empty sets of edges. A highest contribution index is initialized to zero.

Table 1A shows the number of connected components per each topic at the initial condition (e.g., FIG. 3A).

TABLE 1A
Before adding an edge between a new node 4 and other nodes

| Topic | The number of connected components |
|---|---|
| t1 | 2 |
| t2 | 1 |
| t3 | 2 |
| t4 | 1 |
| t5 | 2 |

For topics t1, t3 and t5, there are two connected components (e.g., a node 4 and a connected component comprising a node 1, a node 2, a node 3, an edge (1,2) and an edge (2,3)). For a topic 2, there is a single connected component (a node 1). For a topic t4, there is a single connected component (e.g., a connected component comprising a node 2, a node 3 and an edge (2,3)).

Table 2A shows a contribution value (i.e., a reduction in topic-connected components (TCC)) per each edge at the initial condition (e.g., FIG. 3A).

TABLE 2A
Contribution values at the initial condition

| Edge | Reduction in topic-connected components |
|---|---|
| 1-4 | 2 |
| 2-4 | 2 |
| 3-4 | 2 |

An edge (1,4) has a contribution value 2 (e.g. topics t1 and t3). An edge (2,4) has a contribution value 2 (e.g., topics t1 and t3). An edge (3,4) has a contribution value 2 (e.g., topics t1 and t5). In this example, these edges (1,4), (2,4) and (3,4) are stored at the third element in the link contribution array (e.g., LinkContrib[2]). In this example, a highest contribution index indicates the third element in the link contribution array.

FIG. 3B illustrates an edge (1,4) is added to a set of overlay edges, because the edge (1,4) has the highest contribution value (e.g., its reduction in TCC is 2) and the smallest lexicographical order. #1 (2) on the edge (1,4) in FIG. 3B means that the edge (1,4) is the first edge added to the set of overlay edges, since the new node 4 wants to join the overlay network. The #1 (2) on the edge (1,4) also means that the contribution value of the edge (1,4) is 2. When the edge (1,4) is added to the set of overlay edges, the edge (1,4) is removed form the link contribution array. Accordingly, the number of connected components per each topic is updated. Table 1B shows the update of the number of connected components.

TABLE 1B
After adding an edge between the node 1 and the new node 4

| Topic | The number of connected components |
|---|---|
| t1 | 1 |
| t2 | 1 |
| t3 | 1 |
| t4 | 1 |
| t5 | 2 |

For topics t1 and t3, the number of connected components becomes 1 (e.g., a single connected component comprising a node 1, a node 2, a node 3, a node 4, an edge (1,2), an edge (2,3) and an edge (1,4)). However, there are still two connected components for a topic t5 (e.g., a node 3 and a node 4; the node 3 and the node 4 are not connected for the topic t5).

After adding the edge (1,4) to the set of overlay edges, contribution values of other edges are recalculated. A table 2B illustrates the recalculation of the contribution values of other edges.

TABLE 2B
Contribution values after adding the edge (1, 4) to the
set of overlay edges

| Edge | Reduction in topic-connected components |
|---|---|
| 2-4 | 0 |
| 3-4 | 1 |

Adding the edge (1,4) makes a path between the node 2 and the node 4 for their common topics (e.g., topics t1 and t3). Therefore, the reduction in TCC of edge (2,4) becomes 0. However, the reduction in TCC of the edge (3,4) is 1, because the node 3 and the node 4 are not connected for a topic t5. The edge (3,4) is now stored in the second element of the link contribution array (e.g., LinkContrib[1]). The highest contribution index indicates the second element in the link contribution array.

FIG. 3C illustrates an edge (3,4) is added to a set of overlay edges, because the edge (3,4) has the highest contribution value (e.g., its reduction in TCC is 1). #2 (1) on the edge (3,4) in FIG. 3C means that the edge (3,4) is the second edge added to the set of overlay edges, since the new node 4 wants to join the overlay network. The #2 (1) on the edge (3,4) also means that the contribution value of the edge (3,4) is 1. When the edge (3,4) is added to the set of overlay edges, the edge (3,4) is removed from the link contribution array. The link contribution array becomes an empty set. Then, constructing an overlay network after joining a new node is completed.

Table 1C shows that after adding the edge (3,4), there is single topic-connected component for all the topics (e.g., topics t1-t5).

TABLE 1C
After adding an edge between the node 3 and the new node 4

| Topic | The number of connected components |
|---|---|
| t1 | 1 |
| t2 | 1 |
| t3 | 1 |
| t4 | 1 |
| t5 | 1 |

Finally, adding the edge (3,4) to the set of overlay edges makes there is a single connected component for a topic t5 (e.g., a node 3 and a node 4 are connected through the edge (3,4) for a topic t5).

After adding the edge (3,4) to the set of overlay edges, there is no edge having a contribution value larger than 1. A table 2C shows there is no edge having a contribution value larger than 1. Therefore, the link contribution array became empty.

TABLE 2C
Contribution values after adding the edge (3, 4) to the
set of overlay edges

| Edge | Reduction in topic-connected components |
|---|---|
| 2-4 | 0 |

A value of the highest contribution index becomes zero (i.e., the highest contribution index indicates the first element in the link contribution array (e.g., LinkContrib[0])).

In one exemplary embodiment, FIG. 3A is provided as inputs to steps 3005-3010 of FIG. 7. The FIG. 7 (i.e., the initialization phase of the GJ algorithm) generates connected components (e.g., Nodes[v][t]), a link contribution array (e.g., LinkContrib), a highest contribution index (e.g., HighestContrib) and a set of overlay edges (e.g., OverlayEdges) as outputs by executing steps 3025-3085 of FIG. 7. These outputs of FIG. 7 are provided as inputs to step 2005 of FIG. 6A. At the first iteration of steps 2010-2045 of FIG. 6A, FIG. 3B is generated. At the second iteration of steps 2010-2045 of FIG. 6A, FIG. 3C is generated. After the second iteration, the link contribution array becomes empty (i.e., there is no edge having a contribution value larger than zero). The highest contribution index indicates to zero. The GJ algorithm is completed by generating FIG. 3C as an output. FIG. 3C is a topic-connected overlay network.

When a node leaves a topic-connected overlay network, the overlay network can lose its topic-connectivity. That is, subgraphs induced by topics to which a leaving node was interested in may contain more than one connected component. A Greedy Leave (GL) algorithm repairs such an overlay network (i.e., an overlay network loosing its topic-connectivity due to a leaving node) by adding edges, until the overlay network becomes topic-connected again for all topics. The GL algorithm works by adding an edge at a time. The added edge merges at least two previously disjoint connected components for a largest number of common topics (i.e., a largest contribution value).

The GL algorithm is essentially same with the GM algorithm, except for an initialization phase (i.e., a phase initializing sets of nodes, a link contribution array, a highest contribution index and a set of overlay edges). Following illustrates a pseudo-code of the initialization phase of the GL algorithm.

Algorithm 4 GL Data Structure Initialization

| | |
|---|---|
| 1: | Node w ∈ V leaving an existing topic-connected overlay G(V,E) |
| 2: | T_{w} ← {t ∈ T : Int(w,t)} |
| 3: | N_{w} ← {v ∈ V : (v,w) ∈ E} |
| 4: | E ← E − {(u,w) : u ∈ N_{w}} |
| 5: | V ← V − w |
| 6: | for all t ∈ T_{w} do |
| 7: | NODES[w][t] ← |
| 8: | OUTPUTOVERLAYEDGES← E |
| 9: | for all t ∈ T_{w} do |
| 10: | N_{w}^{t} ← {v ∈ N_{w} : Int(v,t)} |
| 11: | while N_{w}^{t} ≠ do |
| 12: | remove a node u from N_{w}^{t} |
| 13: | C ← |
| | TOPICCONNECTEDCOMPONENTDISCOVERY(G,t,u) |
| 14: | N_{w}^{t} ← N_{w}^{t} − C |
| 15: | for all v ∈ C do |
| 16: | NODES[v][t] ← C |
| 17: | for all e = (v,u) ∈ {V × V − E} do |
| 18: | contrib ← 0 |
| 19: | for all t ∈ T such that Int(v,t) [symbol] Int(u,t) do |
| 20: | if NODES[v][t]∩NODES[u][t] = then |
| 21: | contrib ← contrib + 1 |
| 22: | if contrib > 0 then |
| 23: | add e = (v,u) to LINKCONTRIB[contrib] |
| 24: | HIGHESTCONTRIB← max(i\|LINKCONTRIB[i] not empty) |

Line 1 of algorithm 4 assumes a node w is leaving an existing topic-connected overlay network. It is assumes that the existing topic-connected overlay network has information about a set of overlay edges, sets of nodes in the overlay network, a highest contribution index and a link contribution array. Initially, the set of overlay edges contains all the edges in the topic-connected overlay network. There is a single topic-connected component for every topic in the overlay network (e.g., Nodes[v][t] contains a single topic-connected component induced by every topic t). The highest contribution index has an integer 0 (e.g., the highest contribution index indicate the first element of the link contribution array). All the elements in the link contribution array are empty.

Lines 1-8 of the algorithm 4, the leaving node w is removed from sets of nodes (e.g., Nodes). The node w and edges emanating from the node w are removed from the overlay network. Specifically, at line 2 of the algorithm 4, T_{w} is defined to store all the topics that the leaving node w is interested in. At line 3 of the algorithm, N_{w} is defined to store all the nodes that are connected to the leaving node w. At line 4 of the algorithm 4, edges emanating from the leaving node 4 are removed from a set of edges. At line 5 of the algorithm 4, the leaving node w is removed from a set of nodes. At lines 6-7 of the algorithm 4, for every topics that the leaving node w are interested in, connected component(s) containing all the nodes that are reachable from the leaving node w become empty set. At line 8 of the algorithm 4, a set of edges without emanating edges from the leaving node w are assigned to a set of overlay edges.

The removal of the leaving node w in the existing topic-connected overlay network may cause subgraphs induced by topics that the leaving node w was interested in become partitioned into several topic-connected components. Thus, at lines 9-16 of the algorithm 4, for every topic that the leaving node w was interested in, a “TopicConnectedComponentDiscovery” algorithm is executed to discover connected components of the topic and then connected components (e.g., Nodes) for the topic are updated. In one embodiment, BFS (Breadth First Search) or DFS (Depth First Search) can be used as the “TopicConnectedComponentDiscovery” algorithm. Executing TopicConnectedComponentDiscovery(G,t,u) at line 13 of algorithm 4 discovers connected component of a subgraph of G, induced by topic t, starting from a node u. Resulting nodes comprising the discovered connected components are saved at a set C. In other words, after removing the node w that was interested in topics in the set T_{w}, lines 11-16 of the algorithm 4 starts a connected component search from neighbors of the node w for every topic in the set T_{w}. Specifically, line 14 of the algorithm 4 removes the set C (i.e., a set of nodes in the discovered connected components) from N_{w}^{t} (i.e., a connected component for a topic t in the set T_{w} before the node w leaves). After the line 14 of the algorithm 4, N_{w}^{t} contains all neighbor nodes, which are not connected to the node u, which was the starting node at executing TopicConnectedComponentDiscovery algorithm. After lines 15-16, Nodes[v][t] (i.e., a set of nodes including all the nodes reachable from the node v for a topic t) contains a single connected component for a topic t.

Lines 17-24 of the algorithm 4 go over all the edges that are not part of the overlay network and calculate their contribution values. Calculating a contribution value of an edge (v,u) means counting the number of common topics between a node v and a node u. Lines 19-20 of the algorithm 4 checks, for each topic, whether these two nodes (e.g., a node v and a node u) belongs to a same topic-connected component by evaluating whether two sets of nodes (e.g., Nodes[v][t] and Nodes[u][t]) are disjoint. If these two sets of nodes are disjoint, adding the edge (v,u) merges two connected components (e.g., Nodes[v][t] and Nodes[u][t]) for the topic t. Counting the number of common topics for which two sets of nodes (e.g., Nodes[v][t] and Nodes[u][t]) are disjoint is the contribution of the edge (e.g., edge (v,w)).

At lines 22-23 of the algorithm 4, the edge (v,u) is added to an element in the link contribution array according to its contribution value. Line 24 of the algorithm 4 searches the link contribution array to find a highest element that is not empty. The highest contribution index is set to indicate the highest element in the link contribution array. After line 24 of the algorithm 5, the algorithm 2 (GM algorithm for constructing a topic-connected overlay network) is executed until the algorithm 2 is stopped.

In one embodiment, the algorithm 4 is implemented as hardware on a reconfigurable hardware (e.g., FPGA (Field Programmable Gate Array) or CPLD (Complex Programmable Logic Device)) using a hardware description language (Verilog, VHDL, Handel-C, or System C). In one embodiment, the algorithm 4 is implemented on a semiconductor chip (e.g., ASIC (Application-Specific Integrated Circuit)) using a semi custom design methodology (i.e., designing a chip using standard cells and a hardware description language).

In one embodiment, the algorithm 4 is implemented as software using a programming language (e.g., C, C++, Java, .NET, etc.). In one embodiment, the algorithm 4 is recorded in a computer recordable medium (e.g., CD (Compact Disk), DVD (Digital Versatile Disc), HDD (Hard Disk Drive)) as an instruction (e.g., machine language or assembly language) that is executed by a processor (e.g., Intel® Pentium®, IBM® Power PC®, AMD® Operon®).

In one embodiment, the algorithm 4 is implemented as hardware through a computing device (e.g., a desktop, a laptop, a mainframe, a server, or a workstation) by being executed in the computing device. The computing device comprises, but not limited to include, processor(s), memory(s), display device(s), input/output device(s) and network interface(s).

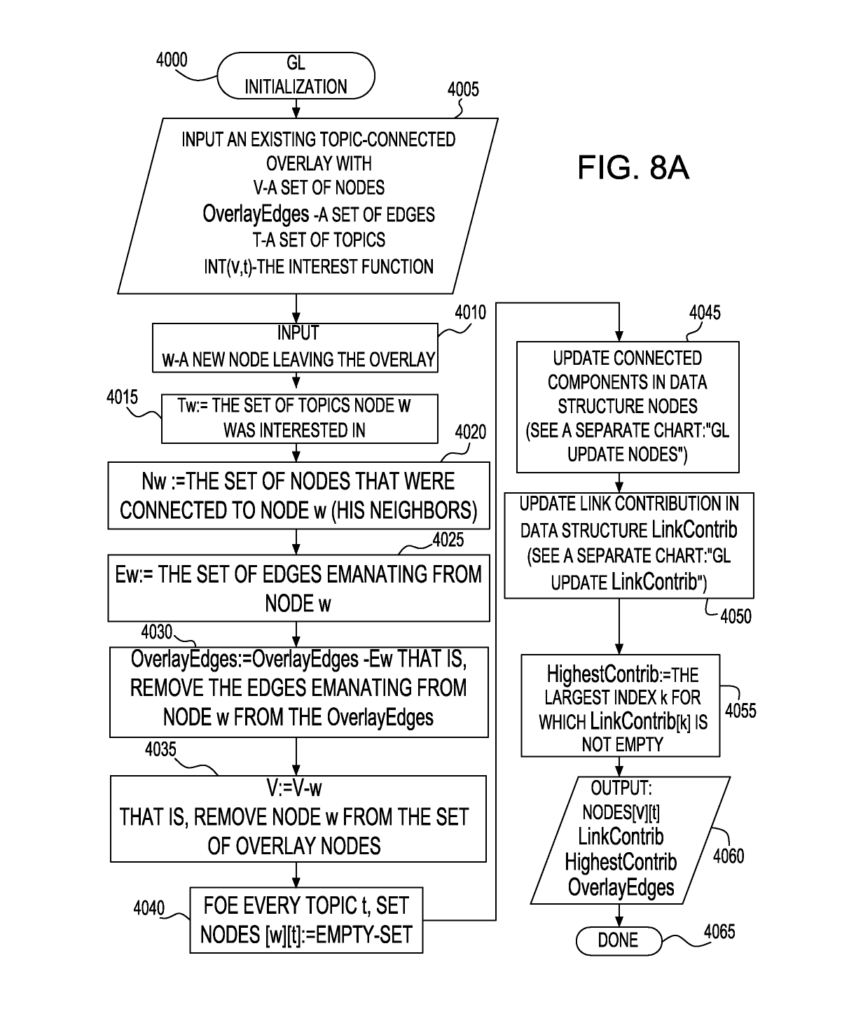

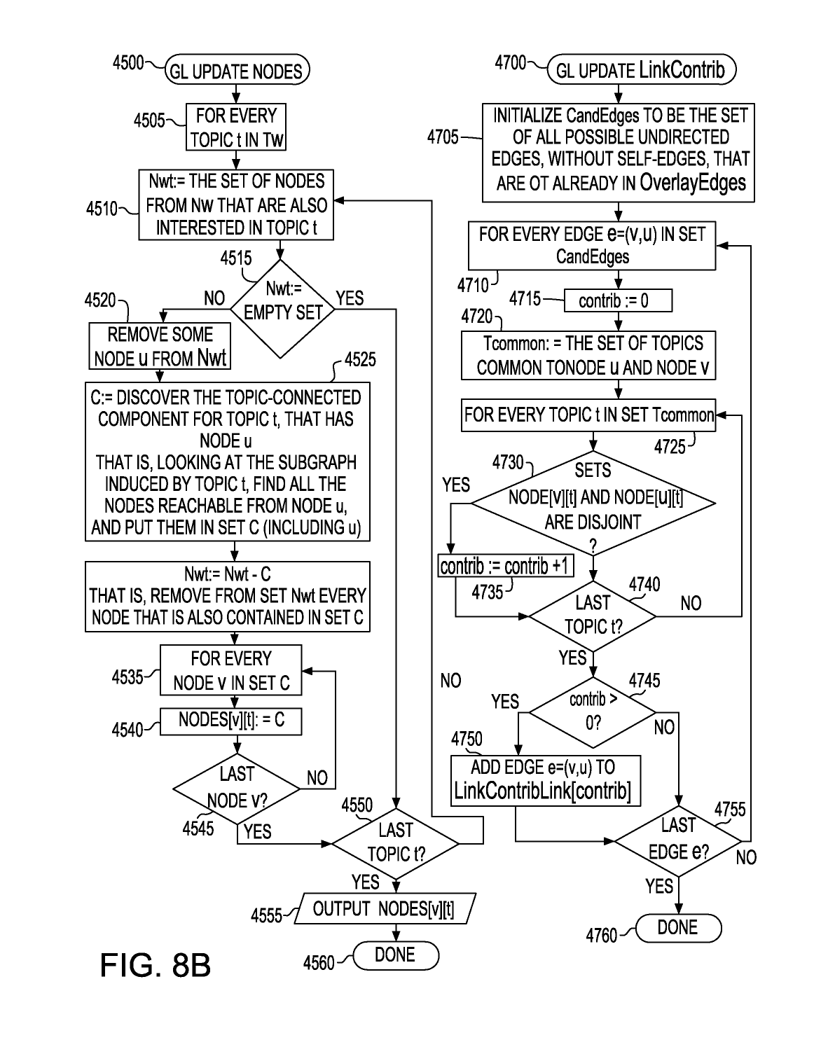

FIGS. 8A-8B illustrate flow charts for an initialization phase of the GL algorithm. At step 4000, the initialization phase of the GL algorithm is started by a user (e.g., a network administrator). At step 4005, an existing topic-connected overlay network is received as an input. In one embodiment, a set of nodes (V), a set of overlay edges, a set of topics (T) and an interest function (e.g., Int(v,t)) are received with the existing topic-connected overlay network as inputs. At step 4005, the set of overlay edges includes all the edges in the existing topic-connected overlay network.

At step 4010, it is notified that a node w wants to leave the existing topic-connected overlay network. At step 4015, a set T_{w} is defined to store topics that the node w is interested in. At step 4020, a set N_{w} is defined to store a set of neighbor nodes that are connected to the node w. At step 4025, a set E_{w} is defined to store edges emanating from the node w. At step 4030, a set of overlay edges are updated by removing the edges emanating from the node w from the set of overlay edges. At step 4035, the set of nodes (V) is updated by removing the node w in the set of nodes (V). At step 4040, for every topic t, a connected component including all the nodes reachable from the node w for the topic t becomes an empty set.

At step 4045, connected components (e.g., Nodes) are updated according to steps 4500-4560 in FIG. 8B (the steps 4500-4560 are explained in detail later). At step 4050, contribution values of edges that are not in the set of overlay edges are calculated according to steps 4700-4760 in FIG. 8B (the steps 4700-4760 are explained in detail later). At step 4055, the link contribution array is searched to find a highest element, which has a set of nodes having a highest contribution value. The highest contribution index is set to indicate the highest element, which is not empty. At step 4060, sets of nodes (e.g., Nodes[v][t]), the link contribution array, the highest contribution index and the set of overlay edges are outputted. The sets of nodes may include multiple separate topic-connected components due to a separation of the node w. Elements in the link contribution array are sorted according to contribution values (e.g., in a descending order of contribution values or in an ascending order of contribution values). The highest contribution index has the highest contribution value of edges in the link contribution array. The set of overlay edges includes all the edges in the existing topic-connected overlay network but edges emanating from the node w. At step 4065, the initialization of the GL algorithm is completed. In one embodiment, the algorithm 2 (i.e., GM algorithm for constructing a topic-connected overlay network) is executed after step 4065.

Steps 4500-4560 in FIG. 8B illustrates updating connected components (e.g., array Nodes), after removing the node w in the set of nodes (V). At step 4500, the updating is initiated by a user (e.g., a network administrator). At steps 4505-4510, for every topic t in the set T_{w}, N_{w}^{t} is defined as a set of nodes from N_{w} (i.e., all nodes the node w are connected to) that are interested in the topic t. At step 4515, it is evaluated whether the set N_{w}^{t} is empty. If the set N_{w}^{t} is empty, step 4550 is processed (the step 4550 is explained in detail later). If the set N_{w}^{t} is not empty, step 4520 is processed.

At step 4520, a node (e.g., a node u) is removed from the set N_{w}^{t}. At step 4525, an algorithm (e.g., BFS and/or DFS) for discovery of topic-connected components having the node u is executed for every topic t in the set T_{w} (i.e., a set of topics that the node w was interested in). The topic-connected components discovered by the algorithm (e.g., BFS and/or DFS) is assigned to a set C. In other words, based on a subgraph induced by every topic t in the set T_{w}, all the nodes reachable from the node u are discovered for the topic t and these nodes are stored in the set C (including the node u).

At steps 4535-4545, for every node v in the set C, nodes in the set C are assigned to a connected component including all the nodes reachable from the node v for the topic t (e.g., Nodes[v][t]:=C). Steps 4535-4545 are repeated until all the nodes in the set C has been processed at the step 4540. At step 4550, it is checked whether all the topics in the set T_{w} has been processed from steps 4505-4550. If all the topics in the set T_{w} has not been processed, steps 4505-4550 are repeated until all the topics in the set T_{w} are processed to update connected components (e.g., Nodes[v][t]). At step 4555, a connected component including all the nodes reachable from the node v for the topic t (e.g., Nodes[v][t]) is provided as an output. At step 4560, updating connected components are completed. In one embodiment, after step 4560, the step 4050 in FIG. 8A or step 4700 in FIG. 8B is executed.

Steps 4700-4760 in FIG. 8B illustrate a detailed process of the step 4050 in FIG. 5A. Steps 4700-4760 calculate contribution values of edges that are not in the set of overlay edges. At step 4700, the calculation of the contribution values is initiated by a user (e.g., a network administrator). At step 4705, CandEdges is defined as a set of all possible undirected edges, without self-edges (i.e., e.g., an edge connecting a node A and the node A; an edge like a ring (i.e., a starting point of the edge and an ending point of the edge is same)), that are not already in the set of overlay edges. Steps 4710-4715, for every edge (v,u) in the set CandEdges, each contribution value of the edge is initialized to zero.

At step 4720, Tcommon is defined as a set of topics common between a node u and a node v, where the node v and the node u is connected through the edge (v,u). At steps 4725-4730, for every topic t in the set Tcommon, it is checked whether two sets of nodes (e.g., Nodes[v][t] and Nodes[u][t]) are disjoint (e.g., by checking whether the node v and the node u belong to a same connected component). If these two sets of nodes are disjoint, at step 4735, the contribution value of the edge (v,u) is increased by one. After increasing the contribution value or if the two sets of nodes are not disjoint, at step 4740, it is checked whether all the topics in Tcommon has been evaluated. Steps 4725-4740 are repeated until the contribution value of the edge (v,u) is updated (e.g., the step 4735) for all the topics in Tcommon.

At step 4745, it is evaluated whether the contribution value of the edge (v,u) is larger than zero. If the contribution value of the edge (v,u) is larger than zero, at step 4750, the edge (v,u) is added to an element in the link contribution array according to the contribution value. For example, the edge (v,u) has a contribution value 2, then the edge (v,u) is added to the third element of the link contribution array (e.g., adding the edge (v,u) to LinkContrib[2]). At step 4755, it is checked whether all the edges in the set CandEdges are evaluated through steps 4710-4755. Steps 4710-4755 are repeated until contribution values of all the edges in CandEdges are calculated and the edges are added to the link contribution array according to their contribution values. At step 4760, the calculation of contribution values of edges that are not in the set of overlay edges are completed. In one embodiment, after step 4760, the step 4055 in FIG. 5A is executed.

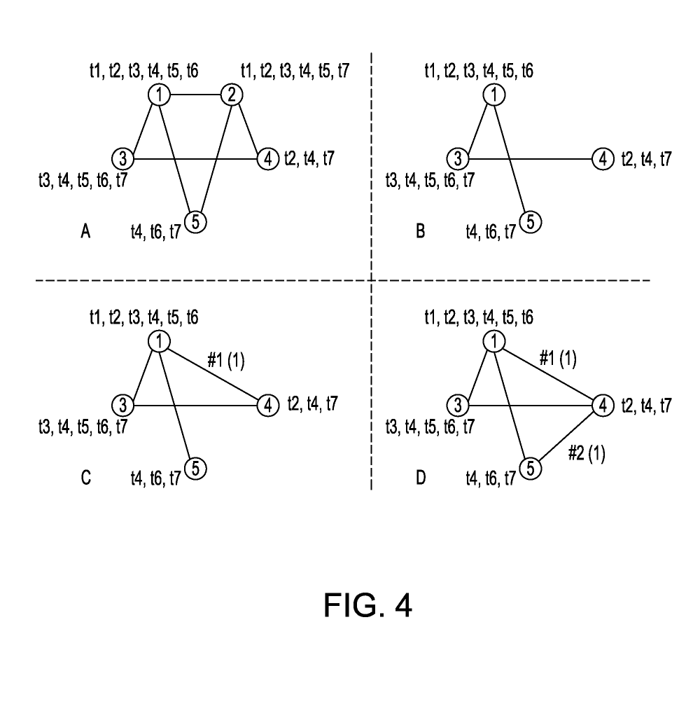

FIG. 4 illustrates a node (e.g., a node 2) leaving an existing topic-connected overlay network (e.g., FIG. 4A). FIG. 4A shows a single topic-connected overlay network comprising five nodes (e.g., a node 1, a node 2, a node 3, a node 4 and a node 5) and six edges (e.g., edges (1,2), (1,3), (1,5), (2,4), (2,5) and (3,4)). The node 1 is interested in topics t1-t6. The node 2 is interested in topics t1-t5 and t7. The node 3 is interested in topics t3-t7. The node 4 is interested in topics t2, t4 and t7. The node 5 is interested in topics t4, t6 and t7. The overlay network in FIG. 4A is topic-connected, because there is a single topic-connected component for every topics (e.g., topics t1-t7).

Table 1D shows the number of connected components (CC) per each topic for the overlay network in FIG. 4A.

TABLE 1D
The number of CC for an overlay network in FIG. 4A

| Topic | The number of connected component |
|---|---|
| t1 | 1 |
| t2 | 1 |
| t3 | 1 |
| t4 | 1 |
| t5 | 1 |
| t6 | 1 |
| t7 | 1 |

Table 1D shows that, for every topics, there is a single connected component. Therefore, the overlay network in FIG. 4A is topic-connected.

Table 2D shows a reduction in the number of topic-connected components (TCC) per each edge.

TABLE 2D
Contribution value per each edge for an overlay network in FIG. 4A

| Edge | Reduction in the number of TCC |
|---|---|
| All | 0 |

Because the overlay network in FIG. 4A is topic-connected, all the edges which are not in the set of overlay edges has a contribution value 0. Therefore, the link contribution array is empty (i.e., the link contribution array stores edges having contribution values larger than 0). The highest contribution index is set to indicate the first element in the link contribution array (e.g., LinkContrib[0]). In other words, the highest contribution index is set to zero.

FIG. 4B illustrates a network configuration after the node 2 has been removed from the overlay network. The node 2 is removed from the set of nodes in the overly network. All the edges emanating from the node 2 are deleted from the set of overlay edges.

Table 1E shows the number of connected components (CC) per each topic after the node 2 has left the overlay network.

TABLE 1E
The number of CC for an overlay network in FIG. 4B

| Topic | The number of connected component |
|---|---|
| t1 | 1 |
| t2 | 2 |
| t3 | 1 |
| t4 | 1 |
| t5 | 1 |
| t6 | 1 |
| t7 | 2 |

Table 1E shows that there are two connected components for topics t2 and t7. For example, for the topic t2, there is no path between the node 1 and the node 2. For the topic t7, there are two connected components (e.g., a node 5, a connected component comprising the node 3, the node 4 and the edge (3,4)).

Table 2E shows a reduction in the number of topic-connected components (TCC) per each edge, after the node 2 leaves the overlay network.

TABLE 2E
Contribution value per each edge for an overlay network in FIG. 4B

| Edge | Reduction in the number of TCC |
|---|---|
| 1-4 | 1 |
| 3-5 | 1 |
| 4-5 | 1 |

After the node 2 leave the overlay network, contribution values of edges that are not in the set of overlay edges are calculated by counting the number of common topics for which two connected components are disjoint. As a result, edges (1,4), (3,5) and (4,5) has a contribution value 1. For example, the node 1 and the node 4 are disjoint for the topic t2. Therefore, adding the edge (1,4) to the set of overlay edges connects the node 1 and the node 4. A connected component comprising the node 3 and the node 4 are not connected to the node 5 for the topic t7. Therefore, adding the edge (3,5) to the set of overlay edges connects the connected component and the node 5. Or, adding the edge (4,5) to the set of overlay edges connects the connected component and the node 5.

After contribution values of the edges (1,4), (3,5) and (4,5) are calculated, the edges (1,4), (3,5) and (4,5) are placed in the second element of link contribution array (e.g., LinkContrib[1]) according to their contribution values. The highest contribution index has an integer 1 to indicate to the second element (e.g., LinkContrib[1]) in the link contribution array. In one embodiment, the first element (e.g., LinkContrib[0]) of the link contribution array is always empty. In another embodiment, the second element of the link contribution array is a lowest element (i.e., an element having edges of a contribution value 1).

In one embodiment, among the edges in the second element in the link contribution array, the edge (1,4) is selected because the edge (1,4) has a smallest lexicographical order. In another embodiment, the edge (4,5) is selected, because it has a largest lexicographical order. In an alternative embodiment, any edge among these edges (e.g., edges (1,4), (3,5) or (4,5)) is selected randomly or arbitrarily.

FIG. 4C illustrates that the edge (1,4) is selected in a deterministic way (e.g., a smallest lexicographical order) and then the edge (1,4) added to the set of overlay edges. #1 (1) on the edge (1,4) indicates the edge (1,4) is the first edge being added to the overlay network after the node 2 left the overlay network. The #1 (1) also means the edge (1,4) has a contribution value 1.

Table 1F shows the number of connected components (CC) per each topic after the edge (1,4) is added to the overlay network.

TABLE 1F
The number of CC for an overlay network in FIG. 4C

| Topic | The number of connected component |
|---|---|
| t1 | 1 |
| t2 | 1 |
| t3 | 1 |
| t4 | 1 |
| t5 | 1 |
| t6 | 1 |
| t7 | 2 |

After adding the edge (1,4) to the set of overlay edges, the overlay network (e.g., FIG. 4C) becomes topic-connected for the topic t2 (i.e., there is a single connected component for the topic t2). The overlay network (e.g., FIG. 4C) is also topic-connected for topics t1-t6. However, there are still two separate connected components (e.g., a node 5, a connected component comprising the node 3 and the node 4) for the topic t7.

Table 2F shows a reduction in the number of topic-connected components TCC) per each edge, after the edge (1,4) is added to the overlay network.

TABLE 2F
Contribution value per each edge for an overlay network in FIG. 4C

| Edge | Reduction in the number of TCC |
|---|---|
| 3-5 | 1 |
| 4-5 | 1 |

After adding the edge (1,4) to the set of overlay edges, the edge (1,4) is removed from the link contribution array. Because there is no edge that connects the connected components (e.g., the node 1 and the node 4) that became connected through the edge (1,4), no update on other edges is made for the reduction in the number of TCC. Therefore, the edges (3,5) and (4,5) are still in the second element of the link contribution array. The highest contribution index still has an integer value 1 to indicate the second element of the link contribution array.

FIG. 4D illustrates the edge (4,5) is selected in a deterministic way (e.g., a largest lexicographical order) to be added to the set of overlay edges. In one embodiment, the edge (3,4) can be selected in another deterministic way (e.g., a smallest lexicographical order) to be added to the set of overlay edges. #2 (1) on the edge (4,5) indicates the edge (4,5) is the second edge being added to the overlay network after the node 2 left the overlay network. The #2 (1) also means the edge (4,5) has a contribution value 1.

Table 1G shows the number of connected components (CC) per each topic after the edge (4,5) is added to the overlay network.

TABLE 1G
The number of CC for an overlay network in FIG. 4D

| Topic | The number of connected component |
|---|---|
| t1 | 1 |
| t2 | 1 |
| t3 | 1 |
| t4 | 1 |
| t5 | 1 |
| t6 | 1 |
| t7 | 1 |

After adding the edge (4,5) to the set of overlay edges, there is a single connected component for the topic t7. Hence, the overlay network shown in FIG. 4D becomes topic-connected for all the topics (e.g., topics t1-t7).

Table 2G shows a reduction in the number of topic-connected components (TCC) per each edge, after the edge (4,5) is added to the overlay network.

TABLE 2G
Contribution value per each edge for an overlay network in FIG. 4D

| Edge | Reduction in the number of TCC |
|---|---|
| 3-5 | 0 |

After adding the edge (4,5) to the set of overlay edges, the edge (4,5) is removed from the link contribution array. Because the edge (3,5) connects the connected components (e.g., a connected components comprising the node 3 and the node 4, the node 5) that became connected through the edge (4,5), a contribution value of the edge (3,5) is recalculated. Because the node 3 and the node 5 are connected through edges (3,4) and (4,5) for topics t4 and t7 and are connected through edges (1,3) and (1,5) for the topic t6, the contribution value of the edge (3,5) becomes zero. Then, the link contribution array became empty (i.e., there is no edge having a contribution value larger than zero). The highest contribution index is set to zero. Therefore, after the node 2 left the existing topic-connected overlay network, the overlay network is repaired to maintain topic-connectivity through exemplary FIGS. 4B-4D.

In one exemplary embodiment, FIG. 4A is provided as an input to step 4005-4010 of FIG. 8A. FIG. 4B illustrates an overlay network, after executing steps 4015-4035 of FIG. 8A. The initialization phase of the GL algorithm (e.g., FIG. 8A) generates outputs such as connected components, a link contribution array, a highest contribution index and a set of overlay edges. These outputs of FIG. 8A are provided to step 2005 of FIG. 6A as inputs. FIG. 4C is generated by first iteration of steps 2010-2045 of FIG. 6A. FIG. 4D is generated by second iteration of steps 2010-2045 of FIG. 6A. After the second iteration, the link contribution array becomes empty (i.e., there is no edge having a contribution value larger than zero). The highest contribution index indicates to zero. The GM algorithm for constructing topic-connected overlay network (e.g., FIG. 6A) is completed by generating FIG. 4D as an output. FIG. 4D is a topic-connected overlay network.

In one embodiment, the GM algorithm (e.g., algorithm 1 and algorithm 2), the GJ algorithm (e.g., algorithm 2 and algorithm 3) and/or the GL algorithm (e.g., algorithm 2 and algorithm 4) are implemented in a centralized architecture (e.g., a client/server environment), in which a topology server (i.e., a server managing a network topology (i.e., arrangement or mapping of elements (e.g., nodes, edges, etc.))) is responsible for executing the GM, GJ and/or GL algorithms. In this embodiment, a node joining an overlay network first contact the topology server, informs the topology server with the node's interest (e.g., topics that the joining node subscribes), and receives a list of nodes to which the joining node connects through edges. A node leaving an overlay network also informs the topology server and then the topology server or the leaving node communicates with remaining nodes in the overlay network to add edges to repair a topology of the overlay network.

In another embodiment, the GM algorithm (e.g., algorithm 1 and algorithm 2), the GJ algorithm (e.g., algorithm 2 and algorithm 3) and/or the GL algorithm (e.g., algorithm 2 and algorithm 4) are implemented in a distributed architecture (e.g., a peer-to-peer environment), in which instance(s) of the GM, GJ and/or GL algorithms are executed in every single node in an overlay network. In this embodiment, an event that a node joins the overlay network or an event that a node leaves the overlay network is notified to all the nodes in the overlay network in a consistent and/or an ordered manner (e.g., a node 1 is always first notified). In this embodiment, the GM, GJ and/or GL algorithms are executed in a deterministic way. The deterministic way is a selection rule (e.g., selecting an edge in an element in the link contribution array, where the element has more than one edge) that yields a same output every time a same input is applied. For example, ordering edges lexicographically or choosing a first edge in an element in the link contribution array is the deterministic way. Then, all the nodes eventually generate same outputs (e.g., same topology) after executing the GM, GJ and/or GL algorithms.

In one embodiment, improving connectivity and/or reducing diameter of the topic-connected components constructed by the GM algorithm (e.g., algorithm 2) can be achieved by executing the GM algorithm several times. For example, the GM algorithm begins with no edges, only a set of nodes (V) and a set of topics (T) that the nodes are interested in. After the GM algorithm is first executed, there is a single topic-connected overlay network comprising the set of nodes (V) and a first set of overlay edges (E1). Then, the set of edges that are not in the first set of overlay edges (E1) is assigned to a set C1. Now, the second execution of the GM algorithm starts with the set of nodes (V) and the set of topics (T). However, at the second execution of the GM algorithm, edges from the set C1 are only selected to be added to the second set of overlay edges (E2). A topic-connected overlay network generated by the two execution of the GM algorithm comprises the set of nodes (V), the set of topics (T), edges (E1) from the first set of overlay edges and edges (E2) from the second set of overlay edges. The number of executions of the GM algorithm depends on a desired connectivity and diameter of the generated overlay network. The execution of GM algorithm can be repeated until there are no more edges.

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method for constructing a topic-connected overlay network on a publish/subscribe system having a plurality of nodes representing computing devices in said overlay network comprising:
deriving the nodes in the publish/subscribe system, a link contribution array including sets of edges as elements and a highest contribution index keeping track of a highest element in the link contribution array, the elements in the link contribution array being sorted in an order according to contribution values of sets of edges, said sets of edges for connecting the nodes, the highest element including edges with a highest contribution value;
initializing a set of overlay edges, the set of overlay edges connecting the nodes for constructing the topic-connected overlay network;
removing an edge from the highest element in the link contribution array, the highest element being indicated by the highest contribution index;
determining whether the highest contribution index is larger than zero;
adding the removed edge to the set of overlay edges, if the highest contribution index is larger than zero;
updating contribution values of other edges, after adding the removed edge to the set of overlay edges;
updating the highest contribution index, if the highest contribution index is larger than zero and the highest element in the link contribution array is empty; and
outputting the set of overlay edges, when all elements in the link contribution array become empty, wherein
the nodes are organized in a single connected component for every topic by the outputted set of overlay edges and the topic-connected overlay network is constructed.

2. The method according to claim 1, wherein the step of updating the highest contribution index is performed by decreasing the highest contribution index by 1.

3. The method according to claim 1, wherein the step of removing an edge is performed randomly or in a deterministic manner.

4. The method according to claim 1, wherein the steps of deriving, initializing, removing, determining, adding, updating contribution values of other edges, updating the highest contribution index and outputting are implemented in a centralized architecture, where a topology server executes the steps of deriving, initializing, removing, determining, adding, updating contribution values of other edges, updating the highest contribution index and outputting.

5. The method according to claim 1, wherein the step of updating contribution values of other edges comprises:
recalculating contribution values of other edges, after adding the removed edge to the set of overlay edges;
obtaining a new connected component by combining two separate connected components through the removed edge;

6. The method according to claim 1, wherein the step of deriving comprises:
initializing the nodes in the publish/subscribe system by defining an unconnected node as a singleton connected component;
calculating an initial contribution of each edge;
adding each edge to the link contribution array according to the calculated contribution;
searching the link contribution array to find the highest element that is not empty; and
setting the highest contribution index to the highest element in the link contribution array.

7. The method according to claim 1, wherein when a new node joins the topic-connected overlay network, the step of deriving comprises:
obtaining the outputted set of overlay edges with the set of nodes, the nodes being organized in a single connected component for every topic by the outputted set of overlay edges;
initializing the highest contribution index to zero;
initializing all elements in the link contribution array empty;
extending the set of nodes to include the new node;
setting the new node as a singleton connected component in all topics that the new node is interested in;
calculating contribution of every edge from the new node to every other node;
adding each edge to the link contribution array according to the calculated contribution;
searching the link contribution array to find the highest element that is not empty; and
setting the highest contribution index to the highest element in the link contribution array.

8. The method according to claim 1, wherein when an node w leaves the topic-connected overlay network, the step of deriving comprises:
obtaining the outputted set of overlay edges with the set of nodes, the nodes being organized in a single connected component for every topic by the outputted set of overlay edges;
initializing the highest contribution index to zero;
initializing all elements in the link contribution array empty;
removing the node w from the set of nodes;
removing edges emanating from the node w in the outputted set of overlay edges;
updating connected components for every topic that the node w was interested in;
calculating contribution values of all edges that are not in the outputted set of overlay edges;
adding each edge to the link contribution array according to the calculated contribution;
searching the link contribution array to find the highest element that is not empty; and
setting the highest contribution index to the highest element in the link contribution array.

9. The method according to claim 8, wherein the step of updating connected components is performed by discovering the connected components by executing a breadth first search or depth first search.

10. The method according to claim 1, wherein the steps of deriving, initializing, removing, determining, adding, updating contribution values of other edges, updating the highest contribution index and outputting are implemented in a distributed architecture, where every node in the publish/subscribe system executes the steps of deriving, initializing, removing, determining, adding, updating contribution values of other edges, updating the highest contribution index and outputting.

11. The method according to claim 1, the steps of deriving, initializing, removing, determining, adding, updating contribution values of other edges, updating the highest contribution index and outputting are repeated until a desired connectivity and diameter of the topic-connected overlay network are achieved.

12. A system for constructing a topic-connected overlay network on a publish/subscribe system having a plurality of nodes representing computing devices in said overlay network comprising:
means for deriving the nodes in the publish/subscribe system, a link contribution array including sets of edges as elements and a highest contribution index keeping track of a highest element in the link contribution array, the elements in the link contribution array being sorted in an order according to contribution values of sets of edges, said sets of edges for connecting the nodes, the highest element including edges with a highest contribution value;
means for initializing a set of overlay edges, the set of overlay edges connecting the nodes for constructing the topic-connected overlay network;
means for removing an edge from the highest element in the link contribution array, the highest element being indicated by the highest contribution index;
means for determining whether the highest contribution index is larger than zero;
means for adding the removed edge to the set of overlay edges, if the highest contribution index is larger than zero;
means for updating contribution values of other edges, after adding the removed edge to the set of overlay edges;
means for updating the highest contribution index, if the highest contribution index is larger than zero and the highest element in the link contribution array is empty; and
means for outputting the set of overlay edges, when all elements in the link contribution array become empty, wherein
the nodes are organized in a single connected component for every topic by the outputted set of overlay edges and the topic-connected overlay network is constructed.

13. The system according to claim 12, wherein the means for updating the highest contribution index comprises means for decreasing the highest contribution index by one.

14. The system according to claim 12, wherein the means for removing an edge is operated randomly or in a deterministic manner.

15. The system according to claim 12, wherein the means for deriving, initializing, removing, determining, adding, updating contribution values of other edges, updating the highest contribution index and outputting are implemented in a centralized architecture, where a topology server comprises the means of deriving, initializing, removing, determining, adding, updating contribution values of other edges, updating the highest contribution index and outputting.

16. The system according to claim 12, wherein the means for updating contribution values of other edges comprises:
means for recalculating contribution values of other edges, after adding the removed edge to the set of overlay edges;
means for obtaining a new connected component by combining two separate connected components through the removed edge;

17. The system according to claim 12, wherein the means for deriving comprises:
means for initializing the nodes in the publish/subscribe system by defining an unconnected node as a singleton connected component;
means for calculating an initial contribution of each edge;
means for adding each edge to the link contribution array according to the calculated contribution;
means for searching the link contribution array to find the highest element that is not empty; and
means for setting the highest contribution index to the highest element in the link contribution array.

18. The system according to claim 12, wherein when a new node joins the topic-connected overlay network, the means for deriving comprises:
means for obtaining the outputted set of overlay edges with the set of nodes, the nodes being organized in a single connected component for every topic by the outputted set of overlay edges;
means for initializing the highest contribution index to zero;
means for initializing all elements in the link contribution array empty;
means for extending the set of nodes to include the new node;
means for setting the new node as a singleton connected component in all topics that the new node is interested in;
means for calculating contribution of every edge from the new node to every other node;
means for adding each edge to the link contribution array according to the calculated contribution;
means for searching the link contribution array to find the highest element that is not empty; and
means for setting the highest contribution index to the highest element in the link contribution array.

19. The system according to claim 12, wherein when a node w leaves the topic-connected overlay network, the means for deriving comprises:
means for obtaining the outputted set of overlay edges with the set of nodes, the nodes being organized in a single connected component for every topic by the outputted set of overlay edges;
means for initializing the highest contribution index to zero;
means for initializing all elements in the link contribution array empty;
means for removing the node w from the set of nodes;
means for removing edges emanating from the node w in the outputted set of overlay edges;
means for updating connected components for every topic that the node w was interested in;
means for calculating contribution values of all edges that are not in the outputted set of overlay edges;
means for adding each edge to the link contribution array according to the calculated contribution;
means for searching the link contribution array to find the highest element that is not empty; and
means for setting the highest contribution index to the highest element in the link contribution array.

20. The system according to claim 19, wherein the means for updating connected components comprises means for discovering the connected components by executing a breadth first search or depth first search.

21. The method according to claim 12, wherein the means for deriving, initializing, removing, determining, adding, updating contribution values of other edges, updating the highest contribution index and outputting are implemented in a distributed architecture, where every node in the publish/subscribe system comprises the means for deriving, initializing, removing, determining, adding, updating contribution values of other edges, updating the highest contribution index and outputting.

22. The method according to claim 12, the means for deriving, initializing, removing, determining, adding, updating contribution values of other edges, updating the highest contribution index and outputting are repeated until a desired connectivity and diameter of the topic-connected overlay network are achieved.

23. A computer program product comprising computer usable medium having computer readable program code means embodied therein for causing a computer to construct a topic-connected overlay network on a publish/subscribe system, the computer program code means in said computer program product comprising computer readable program code means for causing the computer to effect the functions of claim 1.

24. A computer program storage device, readably by machine, tangibly embodying a program of instructions executable by a machine to perform method steps for constructing a topic-connected overlay network on a publish/subscribe system, said method steps comprising the steps of claim 1.
